(19) United States
(12) Patent Application Publication
(10) Pub. No.: US 2015/0371351 A1
(43) Pub. Date: Dec. 24, 2015

(54) SYSTEMS AND METHODS FOR BIDDING ON SERVICES

(71) Applicant: Healthcare Excellence Institute, LLC, Phoenix, AZ (US)

(72) Inventors: Mischa Dick, Phoenix, AZ (US); Marjorie A. Green, Overland Park, KS (US)

(21) Appl. No.: 14/561,160

(22) Filed: Dec. 4, 2014

Related U.S. Application Data
(60) Provisional application No. 62/016,025, filed on Jun. 23, 2014.

(51) Int. Cl. G06Q 50/22; G06Q 30/06

(52) U.S. Cl. CPC G06Q 50/22; G06Q 30/0611

(57) ABSTRACT

Various embodiments described herein provide for systems and methods that manage or otherwise facilitate bidding processes on services (e.g., healthcare services) provided by service providers (e.g., healthcare providers). Such systems and methods may manage or otherwise facilitate solicitation of bids from one or more service providers for a desired service, arrangement (e.g., scheduling) of the desired service based on bidding processes, pre-payment for the desired service before the desired service has been provided, or review of the desired service or a service provider after the desired service has been provided by the service provider.

### CROSS-REFERENCE TO RELATED APPLICATIONS

The present application claims priority to U.S. Provisional Patent Application Ser. No. 62/016,025, filed Jun. 23, 2014 and entitled “Method and System for Bidding Medical Services,” which is incorporated by reference herein.

### BACKGROUND

1. Technical Field

The present system relates generally to bidding on services and, more particularly, bidding on services provided by professional or non-professional service providers.

2. Description of Related Art

Mobile platforms and applications facilitate efficient management and administration of services relating to health, wellness and medical treatment (hereafter, collectively referred to as healthcare services). For instance, healthcare professionals, such as doctors, nurses, therapists, medical administrators, and the like, can use mobile platforms and applications to schedule healthcare appointments, manage medical records, and share healthcare information with respect to a given patient. Use of mobile platforms and applications in the health industry is improving healthcare provider-patient engagement, lowering healthcare costs, and improving general patient satisfaction.

### SUMMARY

Various embodiments described herein provide for systems and methods that manage or otherwise facilitate bidding processes on services (e.g., healthcare services) provided by service providers (e.g., healthcare providers). Such systems and methods may manage or otherwise facilitate solicitation of bids from one or more service providers for a desired service, arrangement (e.g., scheduling) of the desired service based on bidding processes, pre-payment for the desired service before the desired service has been provided, or review of the desired service or a service provider after the desired service has been provided by the service provider.

According to some embodiments, a system or method generates a bid request for a desired healthcare service to be received by a patient and determining, based on the bid request, a set of healthcare provider users that can provide the desired healthcare service. The bid request may be generated in response to a referral, by a referring healthcare provider user (e.g., primary care doctor or nurse practitioner), for the patient to receive the desired healthcare service. The system or method may route the bid request to a subset of the set of healthcare provider users (e.g., for their consideration and response), where the subset of healthcare provider users is selected by the patient from the set of healthcare provider users. Eventually, the system or method may receive, from at least one healthcare provider user in the subset of healthcare provider users, a bid response to the bid request. The system or method may route the bid response to the patient (e.g., for their consideration and response) and, eventually, receive a patient response to the bid response. The system or method may schedule an appointment, with the at least one healthcare provider user, for the desired healthcare service, where the scheduling is based on the patient response. The system or method may receive pre-payment for the desired healthcare service, where the pre-payment is based on the patient response or the bid response. Additionally, the system or method may receive, from the patient, a patient review of the desired healthcare service provided to the patient by the at least one healthcare provider user (e.g., after the patient accepts the bid response and the desired healthcare service has been provided to the patient by the at least one healthcare provider user).

For some embodiments, the bid response from the at least one healthcare provider user comprises an acceptance or a rejection of the bid request by the at least one healthcare provider user, and may further comprise a reason, by the at least one healthcare provider user, for the acceptance or the rejection. Similarly, for some embodiments, the patient response comprises an acceptance or a rejection of the bid response by the patient, and may further comprise a reason, by the patient, for the acceptance or the rejection (e.g., better rating, cheaper, repeat care, or location). Depending on the embodiment, the patient response may comprise a counter bid to the bid response provided by the at least one healthcare provider user.

In various embodiments, the bid response comprises: a bid by the at least one healthcare provider user for providing the patient the desired healthcare service; cost information for the desired health service (e.g., line-item charges relating to providing the desired healthcare service); description of the desired health service as offered by the at least one healthcare provider user; patient co-payment information; patient deductible information; co-insurance contribution information; or patient out-of-pocket (OOP) expense information. In some embodiments, the bid request comprises information regarding healthcare information of the patient, a healthcare service type of the desired healthcare service, a parameter of the desired healthcare service, or a referral instruction by a patient's healthcare provider user for the desired healthcare service.

Various embodiments provide for a computer program product comprising computer instruction codes configured to cause the computer system to perform various operations described herein.

Other features and aspects of various embodiments will become apparent from the following detailed description, taken in conjunction with the accompanying drawings, which illustrate, by way of example, the features of such embodiments.

### BRIEF DESCRIPTION OF THE DRAWINGS

Various embodiments are described in detail with reference to the following figures. The drawings are provided for purposes of illustration only and merely depict some embodiments. These drawings shall not be considered limiting of the breadth, scope, or applicability of embodiments.

FIG. 1 is a block diagram illustrating an example network system that may be used with various embodiments.

FIG. 2 is a block diagram illustrating an example healthcare service bidding system in accordance with various embodiments.

FIG. 3 is a block diagram illustrating an example healthcare service bidding client in accordance with various embodiments.

FIG. 4 is a flowchart illustrating an example method for managing a bid process for a desired healthcare service in accordance with various embodiments.

FIG. 5 is a screenshot of example graphical user interfaces for collecting user information in accordance with various embodiments.

FIG. 6 is a screenshot of an example graphical user interface for a patient user dashboard in accordance with various embodiments.

FIGS. 7-12 are screenshots of example graphical user interfaces for bid requests in accordance with various embodiments.

FIG. 13 is a screenshot of an example graphical user interface for a patient user dashboard in accordance with various embodiments.

FIGS. 14-15 are screenshots of example graphical user interfaces for bid responses in accordance with various embodiments.

FIGS. 16-17 are screenshots of example graphical user interfaces for patient responses in accordance with various embodiments.

FIG. 18 is a screenshot of an example graphical user interface for a patient user dashboard in accordance with various embodiments.

FIGS. 19-21 are screenshots of example graphical user interfaces for a healthcare provider user dashboard in accordance with various embodiments.

FIG. 22 is a screenshot of example graphical user interfaces for bid responses in accordance with various embodiments.

FIG. 23 is a screenshot of an example graphical user interface for patient responses in accordance with various embodiments.

FIG. 24 is a block diagram illustrating an exemplary digital device that can be utilized in the implementation of various embodiments.

### DETAILED DESCRIPTION

Various embodiments provide for systems and methods relating to bidding on services and, more particularly, bidding on services provided by professional or non-professional service providers. For some embodiments, the systems and methods manage or otherwise facilitate bidding processes between a patient and one or more healthcare providers for a healthcare service the patient desires to receive from at least one of those healthcare providers. The systems and methods may manage or otherwise facilitate solicitation of bids from one or more healthcare providers for a desired healthcare service, arrangement (e.g., scheduling) of the healthcare service based on aforementioned bidding process, pre-payment for the desired healthcare service before the desire healthcare service is provided, or permit a patient review of the healthcare service or a healthcare service provider (e.g., healthcare service provider winning the bid process) after the desired healthcare service has been provided by the healthcare service provider. Though various systems and methods are described herein with respect to healthcare service, those skilled in the will appreciate that those same systems and methods can be implemented with respect to other (non-healthcare) services.

As used herein, a user can include, without limitation, a patient, their representative, or their guardian that is a user (“patient user”) or a professional or non-professional healthcare provider that is a user (“healthcare provider user”). Additionally, as used herein, a healthcare provider user will be understood include a user account representing an individual healthcare provider or a healthcare organization capable of providing a patient with healthcare service. For various systems and methods described herein, the patient user may be a legal guardian or conservator for a patient and submitting on behalf of the patient, a bid request for a desired healthcare service to be performed on the patient.

As used herein, a healthcare service can include any healthcare-related service provided by a professional or non-professional healthcare provider, such as a primary-care doctor, a medical specialist (e.g., cardiologist, oncologist, hematologist, ophthalmologist, etc.), a nurse (e.g., nurse practitioner), a medical assistant, medical equipment provider (e.g., durable medical equipment provider), and the like. A healthcare service may include a service provided at a hospital (e.g., general, rehabilitation, research, or children's hospital), clinic (e.g., inpatient or outpatient clinic), lab (e.g., blood lab), or any other medical or healthcare facility. A healthcare service may include testing (e.g., blood testing), medical imaging (e.g., x-ray, MRI, CAT scan, etc.), consultation with a specialist, obtaining medical equipment, and the like. For some embodiments, a healthcare service may be one that is provided to a patient by a healthcare provider based on a referral by your primary-care doctor.

As also used herein, a notification will be understood to include, without limitation, any form of visual, textual, or audio alert or reminder transmitted or received by a computing device. Depending on the embodiment, a given notification may relate to a bid request (e.g., receiving such a bid request from a patient user), a bid response (e.g., receiving a bid response from a healthcare provider user), a patient response (e.g., receiving a patient response from a patient user), a medical appointment (e.g., notification confirming an appointment based on a patient accepting a bid response from a healthcare provider user), a communication between users (e.g., an in-system communication message from a patient user to a healthcare provider user), or some other activity performed by a system or method described herein.

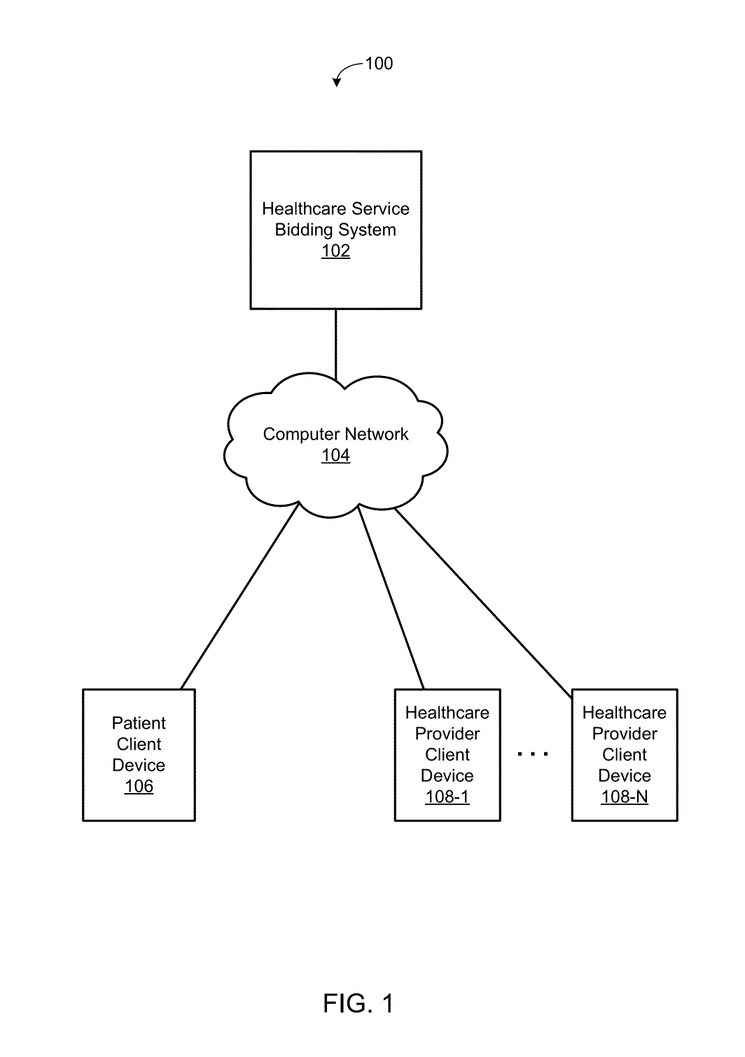

FIG. 1 is a block diagram illustrating an example network system 100 that may be used with various embodiments. As shown in FIG. 1, the example network system 100 can comprise a healthcare service bidding system 102, a patient client device 106, healthcare provider client devices 108-1 through 108-N (hereafter collectively referred to as “healthcare provider client devices 108”), and a computer network 104 communicatively coupling together the healthcare service bidding system 102 each of the patient client device 106, and healthcare provider client devices 108. For illustrative purposes, the patient client device 106 will be understood to be used by a patient user to access the healthcare service bidding system 102, and each of the healthcare provider client devices 108 will be understood to be ones used by professional or non-professional healthcare provider user to access the healthcare service bidding system 102. It will be understood that for some embodiments, the components or the arrangement of components may differ from what is depicted in FIG. 1.

In accordance with some embodiments, the computer network 104 may be implemented or facilitated using one or more local or wide-area communications networks, such as the Internet, WiFi networks, WiMax networks, private networks, public networks, and the like. Depending on the embodiment, some or all of the communication connections with the computer network 104 may utilize encryption (e.g., Secure Sockets Layer [SSL]) to secure information being transferred between the various entities shown in the example network system 100.

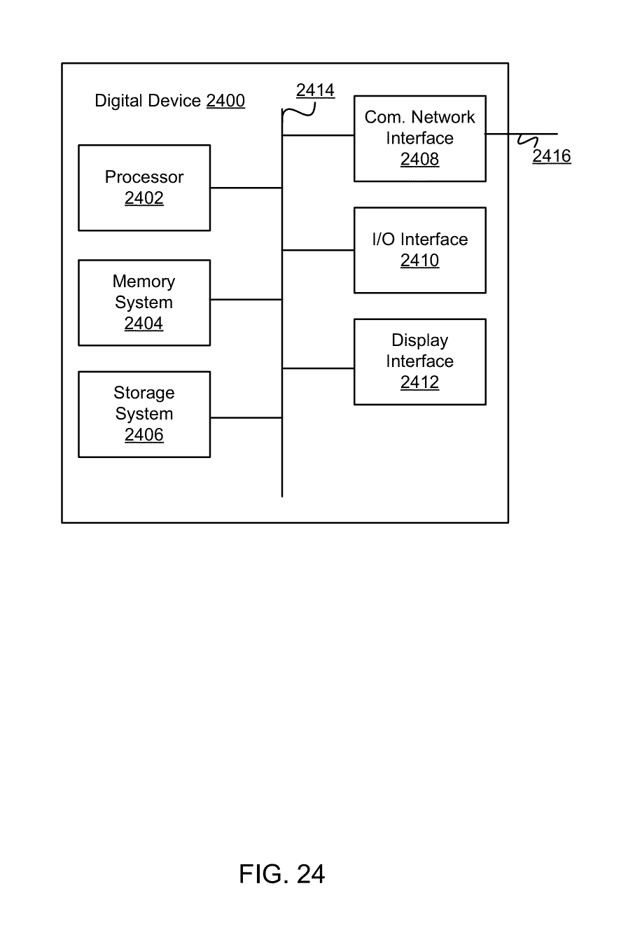

The healthcare service bidding system 102, the patient client device 106, and each of the healthcare provider client devices 108 may be similar to the digital devices discussed later with respect to FIG. 24. For instance, the patient client device 106 may be any form of computing device capable of executing an application, presenting a graphical user interface (GUI) through a display (e.g., a touch screen display) coupled to the computing device, and receiving user input with respect to the GUI. Through interaction with the GUI, a patient user can use the patient client device 106 to interact with healthcare service bidding system 102 and access one or more features offered by the healthcare service bidding system 102 over the computer network 104.

For instance, through the computer network 104, the patient client device 106 can provide, and receive updates to the GUI presented on a touch screen display coupled to the patient client device 106. Through systems or methods described herein, a patient user at the patient client device 106 can create a bid request for a desired healthcare service and can select which healthcare provider users are to receive the bid request, thereby allowing the patient user to solicit bid responses (e.g., bids) from those selected healthcare provider users for the desired healthcare service. As those selected healthcare provider users submit their bid responses (e.g., bids) for providing the desired healthcare service to the patient user, the patient users can be notified of those bid responses through the patient client device 106, and can further review the details of those bid responses through the patient client device 106. Depending on the embodiment, the patient user may choose to respond to the bid response by accepting, rejecting, or ignoring the bid response from the healthcare provider user, and the patient user may choose to counter the bid response with a counter bid. The patient user may choose to include a note, message, or feedback information in their response to the bid response. For some embodiments, the patient user at the patient client device 106 and a given healthcare provider user may participate in multiple iterations of bid responses and patient responses (e.g., counter bid) before the patient user accepts, rejects, or ignores the last bid response from the given healthcare provider user. Once the patient user accepts a given bid response from the given healthcare provider user, the patient user can use the patient client device 106 to facilitate scheduling (e.g., time or date) the desired healthcare service with the given healthcare provider user, and the patient user can use the patient client device 106 to submit some amount of pre-payment (e.g., deposit, co-payment, or total payment) for the desired healthcare service. Additionally, after the given healthcare provider user has provided the desired healthcare service to the patient user, the patient user can use the patient client device 106 to provide a review of (e.g., provide feedback on) the healthcare provider user, the desired healthcare service as provided by the healthcare provider user, or something in relation to both. The review once submitted may be subsequently accessible to the patient user through the patient client device, to another a patient user, to the healthcare provider user, a group of users selected by the patient user, the public, or some combination thereof.

As another example, through the computer network 104, the healthcare provider client devices 108 can provide, and receive updates to the GUI presented on touch screen displays respectively coupled to the healthcare provider client devices 108. Through systems or methods described herein, a healthcare provider user can use one of the healthcare provider client devices 108 to choose to accept, reject, or ignore a bid request from a patient (e.g., a patient user at the patient client device 106) for a desired healthcare service. Where the healthcare provider user accepts the bid request, the healthcare provider user can use one of the healthcare provider client devices 108 to generate a bid response to response to the bid request, thereby allowing the healthcare provider user to submit a bid for providing the desired service to the patient. In the event that the patient accepts the bid response, the healthcare provider user associated with the accepted bid response (e.g., the winning healthcare provider user) user can use one of the healthcare provider client devices 108 to facilitate scheduling the desired healthcare service with the patient, and the healthcare provider user can use one of the healthcare provider client devices 108 to facilitate pre-payment for the desired healthcare service.

For some embodiments, the system or method described herein provide an in-system communication transport whereby the patient user at the patient client device 106 can communicate with one or more of the users at the healthcare provider client devices 108, through the healthcare service bidding system 102, during a bid request, a bid response, a patient response, or a scheduling processes. The in-system communication transport may include audio, video, real-time chat, or electronic mail as mediums of communication. Through in-system communication transport, the system or method can permit a patient user at the patient client device 106 to securely transmit and deliver, to one or more of the users at the healthcare provider client devices 108, select information from patient user's healthcare data.

For various embodiments, an in-system communication transport facilitates communication between a referring healthcare provider user (e.g., primary-care doctor) and another healthcare provider user (e.g., specialist doctor), during a bid request, a bid response, a patient response, or a scheduling process. For example, such a communication transport may enable the other healthcare provider user, once authorized by a patient user, to directly obtain patient-related information from the referring healthcare provider user. The patient-related information received from the referring healthcare provider user may simplify, speed-up, or otherwise facilitate a bid response by the other healthcare provider user to the patient user's bid request.

As used herein, computing devices may include a mobile phone, a tablet computing device, a laptop, a desktop computer, personal digital assistant, a portable gaming unit, a wired gaming unit, a thin client, a set-top box, a portable multi-media player, or any other type of touch-enabled computing device known to those of skill in the art. Further, the healthcare service bidding system 102 may comprise one or more servers, which may be operating on or implemented using one or more cloud-based resources (e.g., System-as-a-Service [SaaS], Platform-as-a-Service [PaaS], or Infrastructure-as-a-Service [IaaS]).

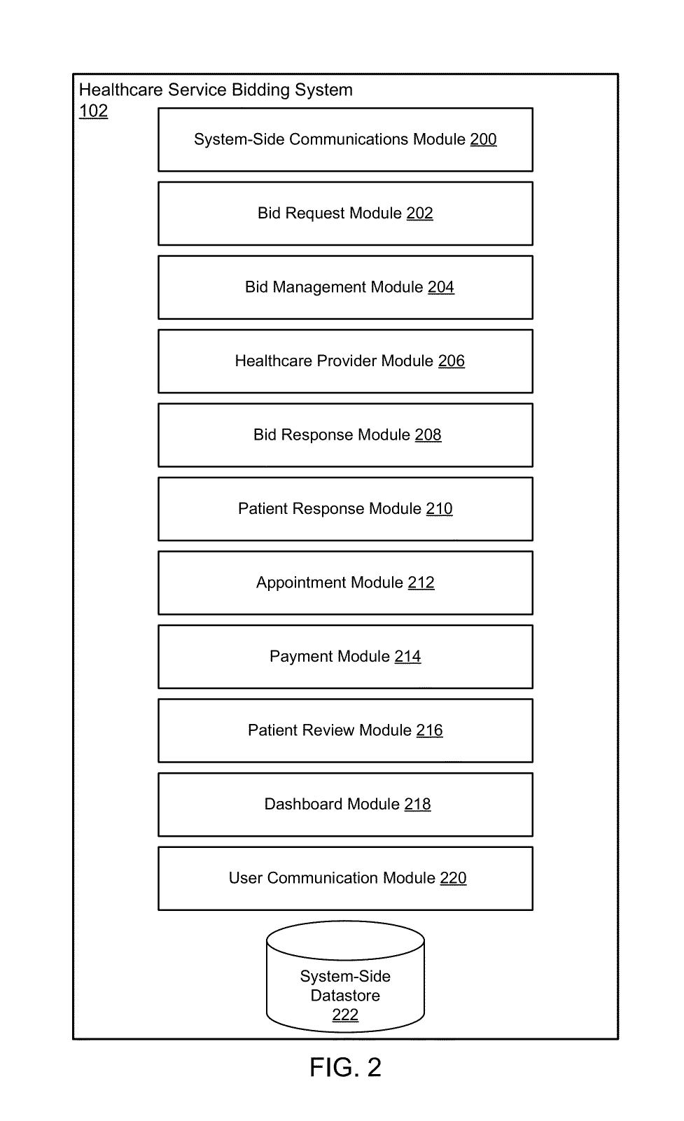

FIG. 2 is a block diagram illustrating an example healthcare data system in accordance with various embodiments. As shown in FIG. 2, the healthcare service bidding system 102 can comprise a system-side communications module 200, a bid management module 204, a bid request module 202, a healthcare provider module 206, a bid response module 208, a patient response module 210, an appointment module 212, a payment module 214, a patient review module 216, a dashboard module 218, a user communication module 220, and a system-side datastore 222. It will be understood that for some embodiments, the components or the arrangement of components may differ from what is depicted in FIG. 2.

The system-side communications module 200 may be configured to facilitate data communication between the healthcare service bidding system 102 and one or more of the patient client device 106 and healthcare provider client devices 108. For instance, as a patient user at the patient client device 106 interacts with the healthcare service bidding system 102, data may be exchanged between the patient client device 106 and the healthcare service bidding system 102 via the system-side communications module 200 over a computer network (e.g., the computer network 104).

The bid request module 202 may be configured to generate or facilitate generation of a bid request, on behalf of a patient user, for a desired healthcare service. As described herein, the bid request may be generated in response to the patient user receiving a referral (e.g., medical order) for the desired healthcare service from one of their existing healthcare provider users (e.g., primary care doctor). Depending on the embodiment, the referral may be submitted by a referring healthcare provider user through the healthcare service bidding system 102. Once generated, the bid request can be submitted (e.g., internally routed) to one or more healthcare provider users (e.g., selected by the patient user) for their consideration and possible response (e.g., accept or reject the bid request). One or more of the receiving healthcare provider users may respond to the bid request by submitting a bid response, which may indicate whether they accept or reject the bid request. Where the bid has been accepted by a receiving healthcare provider user, the receiving healthcare provider user will include in the bid response a bid (e.g., estimate cost) for performing the desired healthcare service. A healthcare provider user receiving the bid request may choose to reject or ignore (e.g., not respond to) the bid request when they do not wish to submit a bid for performing the desired healthcare service. As described herein, the bid request may specify the patient user (or their dependent) who is to receive the desired healthcare service, specify the parameters of the desired healthcare service, include healthcare information for the patient receiving the desired healthcare service, include information regarding the referring healthcare provider user, or include information payment information (e.g., self-pay or insurance policy). The information provided by the bid request can assist healthcare provider users receiving the bid request in preparing their bid response. Depending on the embodiment, healthcare information included in the bid request can include text or multimedia information inputted by a user (e.g., the patient user or a healthcare provider user, a family user or a friend user), existing health conditions, medical history, family history, medication history, currently prescribed medication, prescribed medical regimen, medical, health, or wellness reports, health readings (e.g., biometrics), lifestyle, diet, medical appointments, healthcare reminders and associated settings, healthcare alerts and associated settings, and the like.

The bid management module 204 may be configured to manage a bid process for a desired healthcare service being requested by a patient user, which may include managing a bid request, one or more bid responses, one or more patient responses, scheduling, payment, or current status associated with the bid process. Depending on the embodiment, management of the bid process can include modifying, controlling, canceling, duplicating, or deleting the bid process or various aspects thereof. For example, the bid management module 204 may provide the current status (e.g., pending or completed) a bid process associated with a patient user and a desired healthcare service. The bid management module 204 may permit a patient user to cancel or modify a bid process (e.g., cancel, modify, or resend a bid request or a patient response) associated with a desired healthcare service (e.g., send bid request to more healthcare service providers, or modify the parameters of the desired healthcare service being requested). Additionally, the bid management module 204 may permit a healthcare provider user to cancel, modify or resubmit their bid response to a bid request or a patient response associated with a bid process. Depending on the embodiment, the bid management module 204 may manage storage of data relating to the bid process, which may include storage of data relating to or contained by a bid request, bid response, a patient response, a healthcare service scheduling, or a pre-payment associated with the bid process. Data relating to or contained by a bid request, a bid response, a patient response, a healthcare service scheduling, or a pre-payment associated with the bid process may be stored on the system-side datastore 222.

The healthcare provider module 206 may be configured to search for, filter, or otherwise determine a set of healthcare provider users from which a patient user can select one or more healthcare provider users during a bid process. Depending on the embodiment, the healthcare provider module 206 may determine a set of healthcare provider users that can provide a desired healthcare service for which the patient user is generating a bid request. The set of healthcare provider users can be presented to the patient user, and the patient user can select from the set one or more healthcare provider users from whom the patient user wishes to solicit a bid response for the desired healthcare service. When presented, the set of healthcare provider users may include the location (e.g., address) of the healthcare provider users, contact information, services capabilities, hours of business, insurance coverage, review information (e.g., rating), and the like.

In some embodiments, the healthcare provider module 206 determines a set of healthcare provider users from which the patient user can select (e.g., specify) the referring healthcare provider user ordering the desired healthcare service. By selecting the referring healthcare provider user in this manner (or otherwise providing the identity of the referring healthcare provider user), the patient can include information regarding the referring healthcare provider user in the bid request submitted to the one or more healthcare provider users during the bid process. The information regarding the referring healthcare provider user can not only inform the one or more healthcare provider users of their identity, but may also allow the one or more healthcare provider users to directly contact (e.g., through the user communication module 220) the referring healthcare provider user for additional information before performing the desired healthcare service (e.g., information that can determine how the desired healthcare service should be performed, or healthcare information relating to the patient user, such as medical history).

The bid response module 208 may be configured to generate or facilitate the generation of a bid response, on behalf of a healthcare provider user, to a bid request the healthcare provider user received from a patient user in connection with a desired healthcare service. Once generated, the bid response can be submitted (e.g., internally routed) from the healthcare provider user to the patient user. As described herein, the bid response may indicate acceptance or rejection of the bid request, may include the healthcare provider user's bid for providing the desired healthcare service to the patient user, and may include the healthcare provider user's reason for accepting or rejecting the bid request. With respect to estimated costs, the bid submitted within the bid response may include details regarding what portion of the cost is covered by insurance, what portion is covered by the patient user (e.g., out-of-pocket), amount of co-pay owed, any discounts, amount of deposit required, methods of payment, when payment is due (e.g., scheduled installments), and the like. The bid may provide a line-item listing of labor and goods involved in the healthcare provider user providing the desired healthcare service to the patient user, and one or more of the line-items may detail the estimate cost for the healthcare provider user to provide those line-items.

The patient response module 210 may be configured to generate or facilitate the generation of a patient response, on behalf of a patient user, to a bid response received from a the healthcare provider user. Once generated, the patient response can be submitted (e.g., internally routed) from the healthcare provider user to the patient user. As described herein, the patient response may indicate acceptance or rejection of the bid response provided by the healthcare provider user, and may include the patient user's reason for accepting or rejecting the bid request (e.g., lowest bid, healthcare provider user's rating, etc.). Where the patient response indicates acceptance of a bid response from a healthcare provider user, the healthcare service bidding system 102 may initiate scheduling between the patient user and the healthcare provider user for the healthcare provider user to provide the desired healthcare service to the patient user. Such scheduling may be facilitated through the appointment module 212.

The appointment module 212 may be configured to schedule or facilitate scheduling between a patient user and a healthcare provider user for the healthcare provider user to provide a desired healthcare service to the patient user. When scheduling the desired healthcare service, the appointment module 212 may take into consideration the patient user's time or date preferences to receive the desired healthcare service, which may be contained in (e.g., included by) the bid request generated by the bid request module 202 on behalf of the patient user. Upon a successful scheduling, the appointment module 212 may generate and send an electronic message (e.g., e-mail) to the patient user or the healthcare provider user to confirm the scheduling, or to the patient user or the healthcare provider user to remind them of the scheduling.

The payment module 214 may be configured to facilitate payment from a patient user to a healthcare provider user for a desired healthcare service. Depending on the embodiment, the patient user may utilize the payment module 214 to submit some form of payment with respect to the desired healthcare service, and the patient user may utilize the payment module 214 to submit the payment in advance of the healthcare provider user providing the desired service to the patient user. Payments that may be submitted through the payment module 214 can include, for example, a deposit, out-of-pocket payment (e.g., for costs after insurance coverage), co-payment, or the like.

The patient review module 216 may be configured to permit a patient user to submit a review or rating with respect to a desired healthcare service or a healthcare provider user. Depending on the embodiment, the patient review module 216 may allow the patient user to submit the review or rating after the healthcare provider user has provided the patient user with the desired healthcare service. Additionally, depending on the embodiment, the patient review module 216 may solicit the patient user for the review or the rating (e.g., via e-mail) after the healthcare provider user has provided the patient user with the desired healthcare service. Once submitted, a review or a rating associated with a healthcare service or healthcare provider user may be accessible by another patient user, for example, when the other patient user wishes to select one or more healthcare provider users to generate a bid request.

The dashboard module 218 may be configured to provide a graphical user interface dashboard for a patient user or a healthcare provider user, where the graphical user interface dashboard can provide details (e.g., summarized information) regarding a bid process being facilitated through the healthcare service bidding system 102. For instance, the dashboard module 218 may provide a patient user with a graphical user interface dashboard that summarizes the current status of bid requests generated by the bid request module 202 (e.g., active, pending bid response, completed, etc.), or that summarizes current status of bid responses accepted by the patient user (e.g., a desired healthcare service associated with the accepted bid response is awaiting scheduling). In another example, the dashboard module 218 may provide a healthcare provider user with a graphical user interface dashboard that summarizes the current status of bid responses generated by the bid response module 208 (e.g., pending patient response), or that summarizes current status of bid responses accepted by the patient user (e.g., a desired healthcare service associated with the accepted bid response is awaiting scheduling).

The user communication module 220 may be configured to facilitate in-system communication between two or more users of the healthcare service bidding system 102. In some embodiments, the user communication module 220 helps implement a secure and confidential communication medium between two or more users of the healthcare service bidding system 102, which can include voice (e.g., phone call or voice chat), chat, messages, and exchange of healthcare information, which may be textual or multimedia in form. Features of the user communication module 220 may be utilized, for example, between a patient user and a healthcare provider user during a bid process (e.g., bid request, bid response, patient response, etc.) or between a healthcare provider user receiving a bid request and the referring healthcare provider user ordering the desired healthcare service for the patient user.

Through the in-system communication, the user communication module 220 can enable bid requests, bid responses, patient responses, reviews, pre-payment, healthcare information and the like to be exchanged between users (e.g., patient users and healthcare provider users) without need or use of an external communication system. In doing so, the user communication module 220 can allow the exchange of bid requests, bid responses, patient responses, reviews, pre-payment, healthcare information and the like to remain securely confined within the healthcare service bidding system 102.

The system-side datastore 222 may be configured to implement or facilitate data storage with respect to various components of the healthcare service bidding system 102, including data storage of healthcare information of a patient user and information relating to a healthcare provider user, bid requests, bid responses, patient responses, counter bids, appointment scheduling, healthcare provider reviews, healthcare service reviews, pre-payment, in-system communication, notifications, and the like. Depending on the embodiment, the system-side datastore 222 may be implemented by a database or the like. Those skilled in the art will appreciate that various actions (e.g., accessing, generating, receiving, exchanging, and storing) performed by the healthcare service bidding system 102 with respect to patient healthcare information, bid requests, bid responses, patient responses, reviews, and the like may be performed in compliance with one or more government regulations (e.g., state or federal), such as those enumerated by HIPAA and the like.

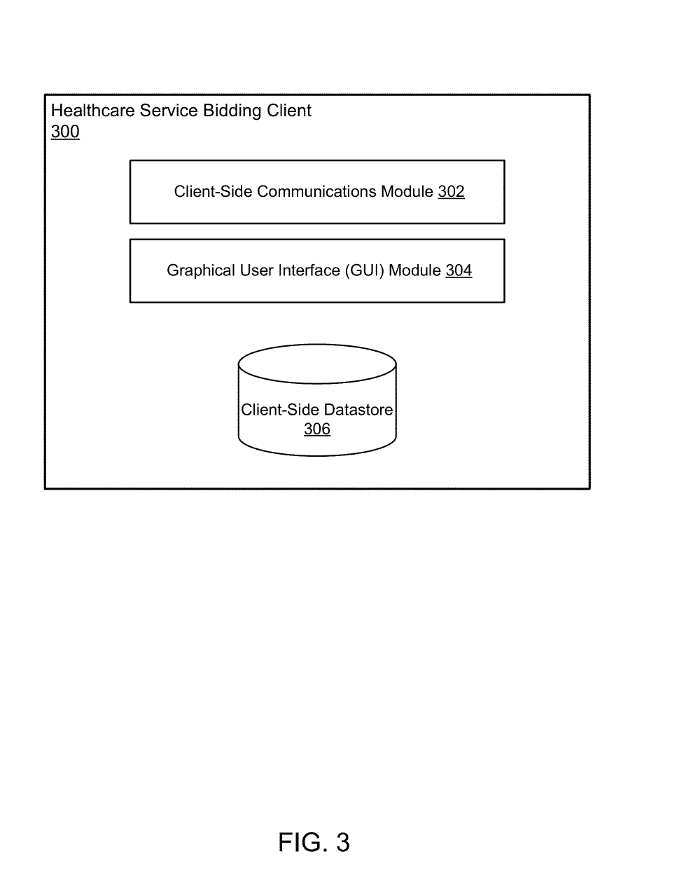

FIG. 3 is a block diagram illustrating an example healthcare service bidding client 300 in accordance with various embodiments. For some embodiments, the healthcare service bidding client 300 is included by a client device, such as the patient client device or one of the healthcare provider client devices 108, to facilitate access to, and user interaction with, one or more features of the healthcare service bidding system 102. For instance, one or more of the patient client device 106, and the healthcare provider client devices 108 can include the healthcare service bidding client 300 in order to facilitate access and interaction between their respective users and the healthcare service bidding system 102. Depending on the embodiment, the healthcare service bidding client 300 may be implemented as a module that can be included by, or coupled to, the client device. For example, the healthcare service bidding client 300 may be implemented as a touch-enabled software application that can operate on a client device (e.g., mobile device) and that can permit a patient user to generate a bid request, a patient response, or a review of a healthcare provider user or the healthcare service they provide the patient user, or can permit a healthcare provider user to generate a bid response or initiate scheduling of a healthcare service for a patient user. In another example, the healthcare service bidding client 300 may include a web browser application that can receive, from the healthcare service bidding system 102, one or more web pages (e.g., HTML pages) having one or more graphical user interfaces, where the graphical user interfaces enable user access or interaction with features provided by the healthcare service bidding system 102. As shown in FIG. 3, healthcare service bidding client 300 can comprise a client-side communications module 302, a graphical user interface (GUI) module 304, and a client-side datastore 306. It will be understood that for some embodiments, the components or the arrangement of components may differ from what is depicted in FIG. 3.

The client-side communications module 302 may be configured to facilitate data communication between the healthcare service bidding client 300 (e.g., including by the patient client device 106 or the healthcare provider client device 108-1) and a healthcare service bidding system 102. In one example, as a healthcare provider user interacts with the healthcare service bidding system 102 through the GUI module 304 of the healthcare service bidding client 300, data may be exchanged between the healthcare service bidding client 300 and the healthcare service bidding system 102 via the client-side communications module 302 over a computer network (e.g., the computer network 104).

The GUI module 304 may be configured to facilitate the generation or presentation of various graphical user interfaces of the healthcare service bidding client 300, which may allow the user to interact with or access features provided by the healthcare service bidding system 102. For example, the GUI module 304 may operate in conjunction with (and therefore enable) one or more of the bid request module 202, the bid management module 204, the healthcare provider module 206, the bid response module 208, the patient response module 210, the appointment module 212, the payment module 214, the patient review module 216, the dashboard module 218, and the user communication module 220 to implement their respective graphical user interfaces.

The client-side datastore 306 may be configured to implement or facilitate data storage with respect to various components of the healthcare service bidding client 300, including data storage of healthcare information, bid requests, bid responses, patient responses, reviews and the like received at the healthcare service bidding client 300 in connection with one or more users accessing the healthcare service bidding system 102 using the healthcare service bidding client 300. Depending on the embodiment, the client-side datastore 306 may be implemented by a database or the like. For some embodiments, the client-side datastore 306 enables a user at the healthcare data client to work offline (e.g., where the healthcare service bidding client 300 is a stand-alone application). For instance, where the healthcare service bidding client 300 received a bid request, a bid response, a patient response, or a review from the healthcare service bidding system 102 (e.g., in the course of a user interacting with the healthcare service bidding system 102), the client-side datastore 306 can store the received information locally such that a user at the healthcare service bidding system 102 can continue to access the received data even in the event that the healthcare service bidding client 300 is unable to subsequently communicate with the healthcare service bidding system 102. As another example, in the event that the healthcare service bidding client 300 is unable to communicate with the healthcare service bidding system 102, a bid request, a bid response, a patient response, or a review received from a user at the healthcare service bidding client 300 can be locally stored at the client-side datastore 306 and later synchronized with the healthcare service bidding system 102 once communication resumes.

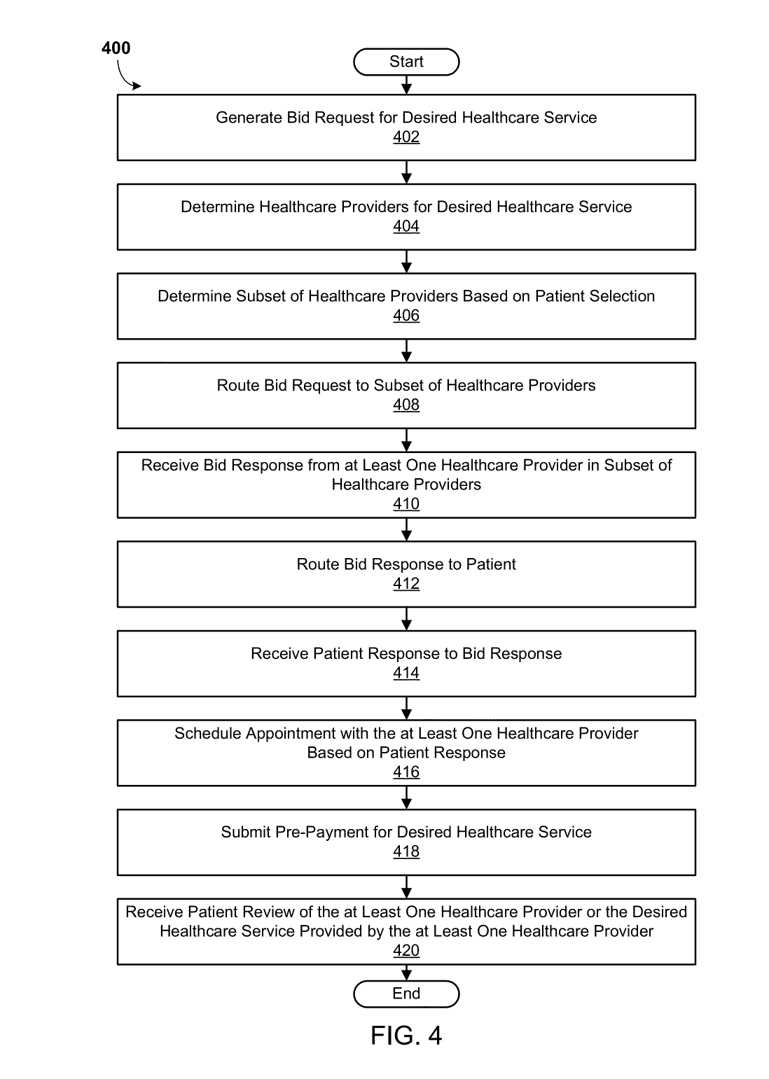

FIG. 4 is a flowchart illustrating an example method 400 for managing bids for healthcare services in accordance with various embodiments. As described below, for some embodiments, the method 400 may perform operations in connection with the healthcare service bidding system 102. The method 400 may start at operation 402, with the bid request module 202 generating a bid request for a desired healthcare service on behalf a patient user at a patient client device (e.g., the patient client device 106). Depending on the embodiment, the bid request module 202 may generate a bid request upon instruction from the patient user (e.g., at the patient client device 106), or may generate the bid request in response to a referral received by the healthcare service bidding system 102 from a healthcare provider user associated with the patient user (e.g., the patient user's primary care doctor). The referring healthcare provider user may be a healthcare provider user of the healthcare service bidding system 102.

At operation 404, the healthcare provider module 206 can determine a set of healthcare provider users (e.g., a listing of healthcare provider users) that can provide the desired healthcare service to the patient user. For instance, the healthcare provider module 206 can permit the patient user to search for, and possibly subsequently filter through, a listing of healthcare provider users capable of performing the desired healthcare service on the patient user. The determined healthcare provider users may be presented to the patient user as a listing of healthcare provider users from which the user can select one or more healthcare provider users to submit the bid request generated at operation 402.

At operation 406, the healthcare provider module 206 can determine, from the healthcare provider users determined at operation 404, a subset of healthcare provider users based on one or more patient user selections (e.g., one or more healthcare provider users selected by the patient user). The subset of healthcare provider users may be those selected from the determined healthcare provider users after the patient user has filtered the determined healthcare provider users using one or more filter parameters. Example filter parameters can include a geographical locations (e.g., address, distance from home or work, etc.), reviews (e.g., rating of the healthcare provider users), types of insurance accepted (e.g., HMO, PPO, EPO, prescription insurance, etc.), availability (e.g., hours of business), educational background, and the like.

At operation 408, the bid request module 202 can route the bid request, generated at operation 402, to the subset of healthcare provider users determined at operation 406. Depending on the embodiment, the bid request may be internally routed within the healthcare service bidding system 102 from the patient user to one or more of the healthcare provider users included in the subset of healthcare provider users. Once routed to the subset of healthcare provider users, the bid request can be reviewed and considered by those healthcare provider users. One or more of the subset of healthcare provider users may respond to the bid request by accepting the bid request (e.g., when they individually wish to submit a bid in response to the bid request), or by ignoring or rejecting the bid request (e.g., when they do not wish to submit a bid in response to the bid request).

At operation 410, the bid response module 208 can receive a bid response from at least one healthcare provider user in the subset of healthcare provider users determined at operation 406. Depending on the embodiment, the at least one healthcare provider user may include a note (e.g., reason for accepting or rejecting) with their bid response, which the patient user can access when reviewing the bid response.

At operation 412, the bid response module 208 can route the bid response received from the at least one healthcare provider user to the patient user associated with the bid request generated at operation 402. Depending on the embodiment, the bid response may be internally routed within the healthcare service bidding system 102 from the at least one healthcare provider user to the patient user. Once routed to the patient user, the bid response can be reviewed and considered by the patient user. The patient user may respond to the bid response by accepting the bid response (e.g., when the patient user accepts the bid from the at least one healthcare provider user), or by ignoring or rejecting the bid response (e.g., when the patient user do not wish to accept the bid from the at least one healthcare provider user).

At operation 414, the patient response module 210 can receive a patient response from the patient user in response to the bid response received at operation 410 and routed to the patient user at operation 412. Depending on the embodiment, the patient user may include a note (e.g., reason for accepting or rejecting) with their patient response, which the at least one healthcare provider user can access when reviewing the patient response. The patient response module 210 may route the patient response to the at least one healthcare provider user, and may do so internally routed within the healthcare service bidding system 102.

Based on the patient response, at operation 416, the appointment module 212 can schedule an appointment between the patient user and the at least one healthcare provider user for the at least one healthcare provider user to provide the desired healthcare service to the patient user. For instance, the appointment module 212 may initiate appointment scheduling when the patient response indicates that the patient user accepts the bid response from the at least one healthcare provider user.

At operation 418, the payment module 214 can facilitate submission of a pre-payment from the patient user to the healthcare provider user for the desired healthcare service. Through the payment module 214, the patient user may submit pre-payment at or around the time of scheduling the appointment for the desired healthcare service. Depending on the embodiment, the pre-payment may include a co-payment, partial payment, or full payment associated with the desired healthcare service. The patient user may submit pre-payment via credit card, electronic payment (e.g., PayPal®), wire, image of a check, or the like.

At operation 420, the patient review module 216 can receive from the patient user a review of the at least one healthcare provider user or the desired healthcare service provided by the at least one healthcare provider user. Depending on the embodiment, the healthcare service bidding system 102 may automatically solicit a review from the patient user at the time of or after the scheduled appointment. The review may include a note or a rating for the at least one healthcare provider user or the desired healthcare service provided.

Though the operations of the above method may be depicted and described in a certain order, those skilled in the art will appreciate that the order in which the operations are performed may vary between embodiments, including performing certain operations in parallel.

Additionally, those skilled in the art will appreciate that the components described above with respect to the method 400 of the flowchart are merely examples of components that may be used with the method, and for some embodiments other components may also be utilized in some embodiments.

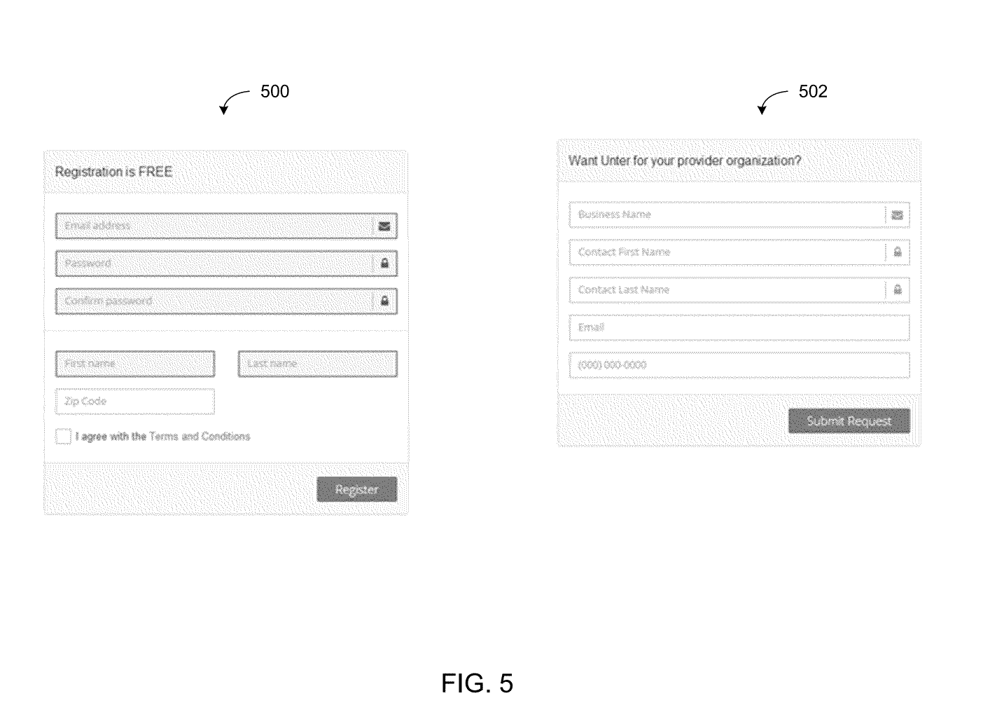

FIGS. 5-23 present screenshots of graphical user interfaces that may be implemented by various embodiments, and that may be utilized by a user (e.g., patient user or healthcare provider user) to interact with a system describe herein, such as the healthcare service bidding system 102, through a client described herein, such as the healthcare service bidding client 300. Those skilled in the art will appreciate that various embodiments may include more, less, or different graphical user interfaces than those depicted in FIGS. 5-23.

FIG. 5 is a screenshot of example graphical user interfaces 500 and 502 for collecting user information in accordance with various embodiments. Depending on the embodiment, the graphical user interface 500 may be used by an individual patient to register as a patient user on the healthcare service bidding system 102. As shown in FIG. 5, the graphical user interface 500 may include graphical elements configured to obtain the patient's contact information (e.g., e-mail address or phone number), a desired password, their full name, and their address (e.g., work or residential address or zip code). In some embodiments, the patient user's current geographical location, or their recorded work or residential address, can be utilized to determine (e.g., search) one or more healthcare provider users that are local or convenient to the individual and that can provide the individual the desired healthcare service. The graphical user interface 500 can also include graphical elements that obtain from the patient demographic information, which can be utilized when a patient user is generating a bid request on the healthcare service bidding system 102. Upon successful registration, the patient may receive an e-mail or some other form of messaging (e.g., text message) that includes a web link that permits the patient user to confirm their contact information.

The graphical user interface 502 may be used by an individual healthcare provider user (e.g., a healthcare provider organization including a primary care doctor or specialist for referrals) to register as a healthcare provider user on the healthcare service bidding system 102. As shown in FIG. 5, the graphical user interface 502 may include graphical elements be configured to collect the healthcare provider user's business name, and contact information (e.g., e-mail address or phone number). Using the information provided, the status of the healthcare provider user may be verified before the healthcare provider user is registered as a healthcare provider user on the healthcare service bidding system 102. After a successful verification, the healthcare provider user can complete their registration by providing desired password, information regarding healthcare services provided by the healthcare provider user, information regarding insurance accepted by the healthcare provider user, and the like. Information collected from the healthcare provider user can be used when determining (e.g., searching for) healthcare provider users that can provider a patient user with a desired healthcare service.

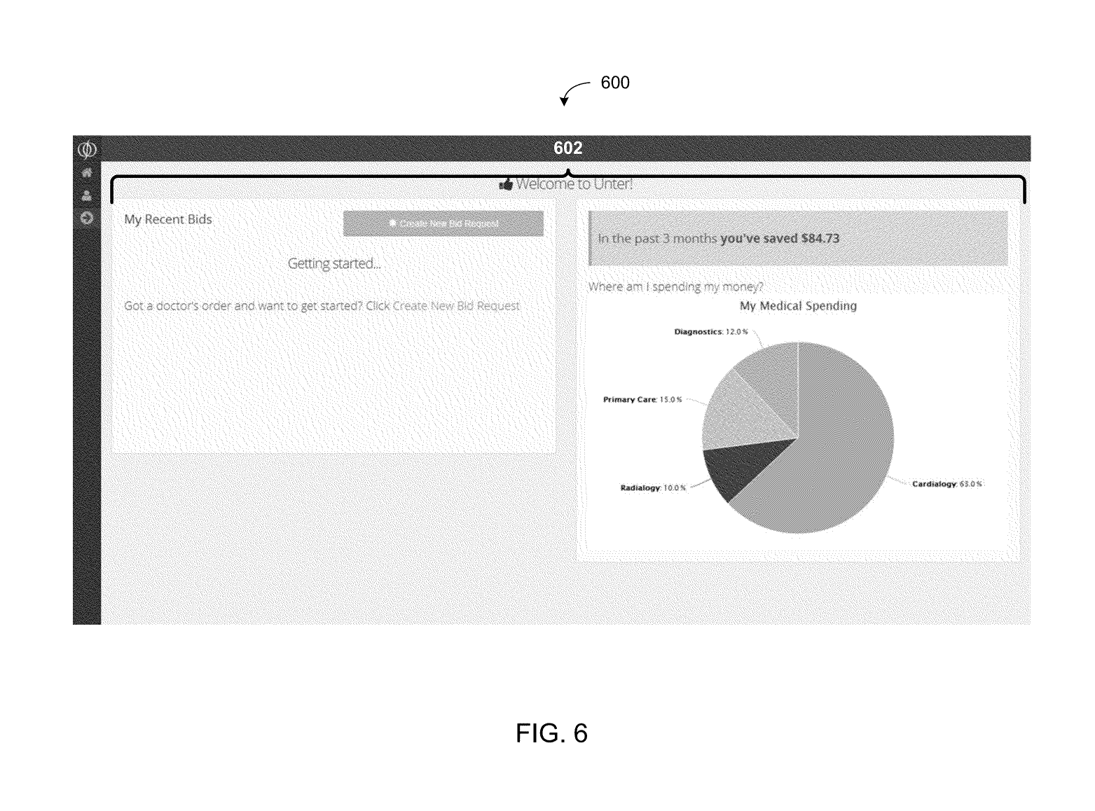

FIG. 6 is a screenshot of an example graphical user interface 600 for a patient user dashboard in accordance with various embodiments. As shown in FIG. 6, the graphical user interface 600 can include graphical user interface features 602 that can allow the patient user to create a new bid request for a desired healthcare service and that can provide the patient user with information relating to bid requests they have already generated, such information including the current status of the generated bid requests and details regarding the desired healthcare service through those bid requests. With respect to the current status of the bid request, the graphical user interface features 602 can indicate whether the bid request is still active (e.g., pending) or completed, how many healthcare provider users bid request was submitted to, whether the bid request is awaiting bid responses or already has an accepted bid response, how many bid responses have been received in response to the bid request, or whether there are bid responses still awaiting the patient user's consideration. Details regarding the desired healthcare service being requested may include a summary describing the desired healthcare service being requested, one or more parameters of the desired healthcare service requested, whether the desired healthcare service is based on a referral, which healthcare provider user provided the referral, or when the bid request was generated.

For some embodiment, the graphical user interface features 602 provides a summary of the costs or money expended by the patient user on one or more desired healthcare services scheduled for the patient user through the healthcare service bidding system 102. The summary may include graphical representations of the patient user's healthcare spending, such as bar graphs or pie charts, and include details regarding the money saved by the patient user through use of the healthcare service bidding system 102.

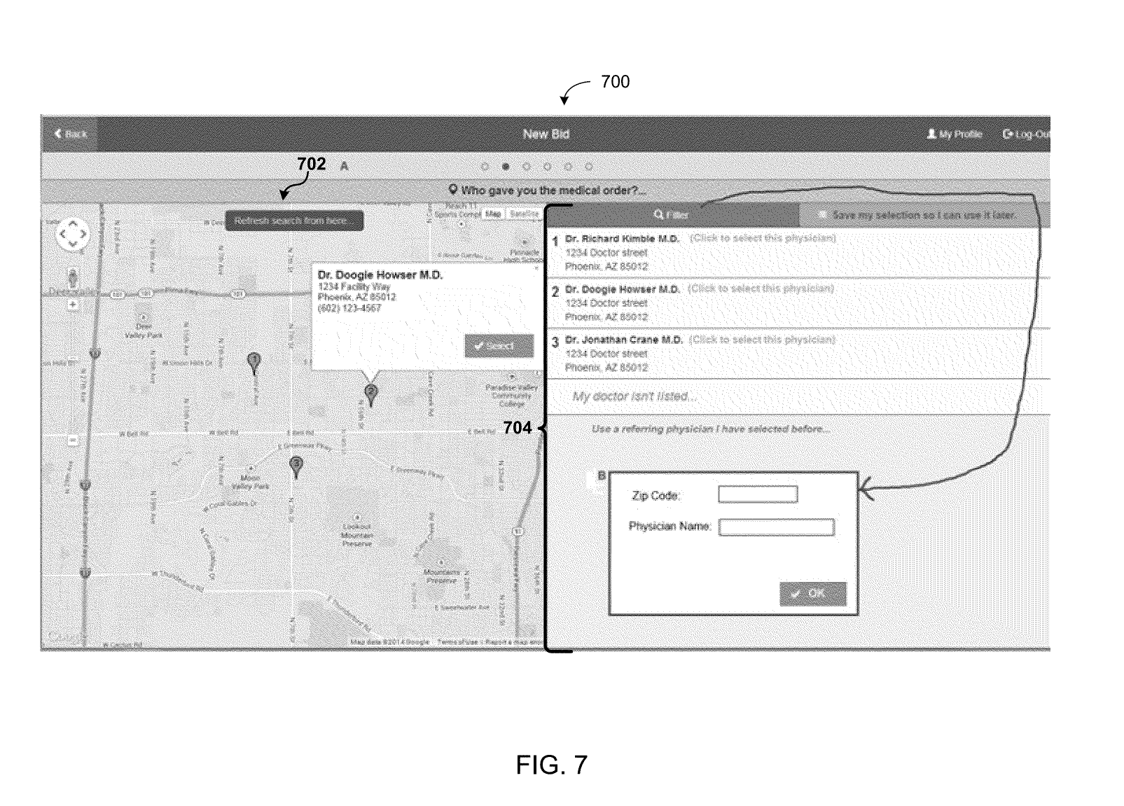

FIG. 7 is a screenshot of an example graphical user interface 700 for bid requests in accordance with various embodiments. In particular, during generation of a bid request for a desired healthcare service, the patient user can utilize the graphical user interface 700 to search for, select or otherwise specify the healthcare provider user (e.g., primary care doctor) who is referring the patient user for the desired healthcare service (e.g., who created the medical order for the patient user to receive the desired healthcare service). As shown in FIG. 7, the graphical user interface 700 can include a graphical user interface feature 702 configured to present on a map the location of one or more healthcare provider users that may be the patient user's referring healthcare provider user. Through the graphical user interface feature 702, the patient user may select one of the healthcare provider users as their referring healthcare provider user.

As also shown in FIG. 7, the graphical user interface 700 can include a graphical user feature 704 that provides a listing of healthcare provider users from which the patient user can select their referring healthcare provider user. Some or all of the healthcare provider users listed by the graphical user interface feature 704 may have their location (e.g., business address) presented on map provided by the graphical user interface feature 702. Depending on the embodiment, the healthcare provider users presented by the graphical user interface feature 702 or 704 is based on one or more search parameters provided (e.g., zip code or healthcare provider name entered) by the patient user (e.g., healthcare provider name or address), the current location of the patient user (e.g., based on GPS information provided by a mobile client device), or based on information the healthcare service bidding system 102 already posses with respect to the patient user (e.g., the patient user's current residential address or healthcare information, which may be included in the patient user's user profile). The initial set of healthcare provider users presented by the graphical user interface feature 702 or 704 can be filtered the patient user based on one or more filter parameters (e.g., keywords or attributes related to the healthcare provider users, such as zip code, distance from the patient user, healthcare provider name, in-network healthcare provider, out-of-network healthcare provider, and the like).

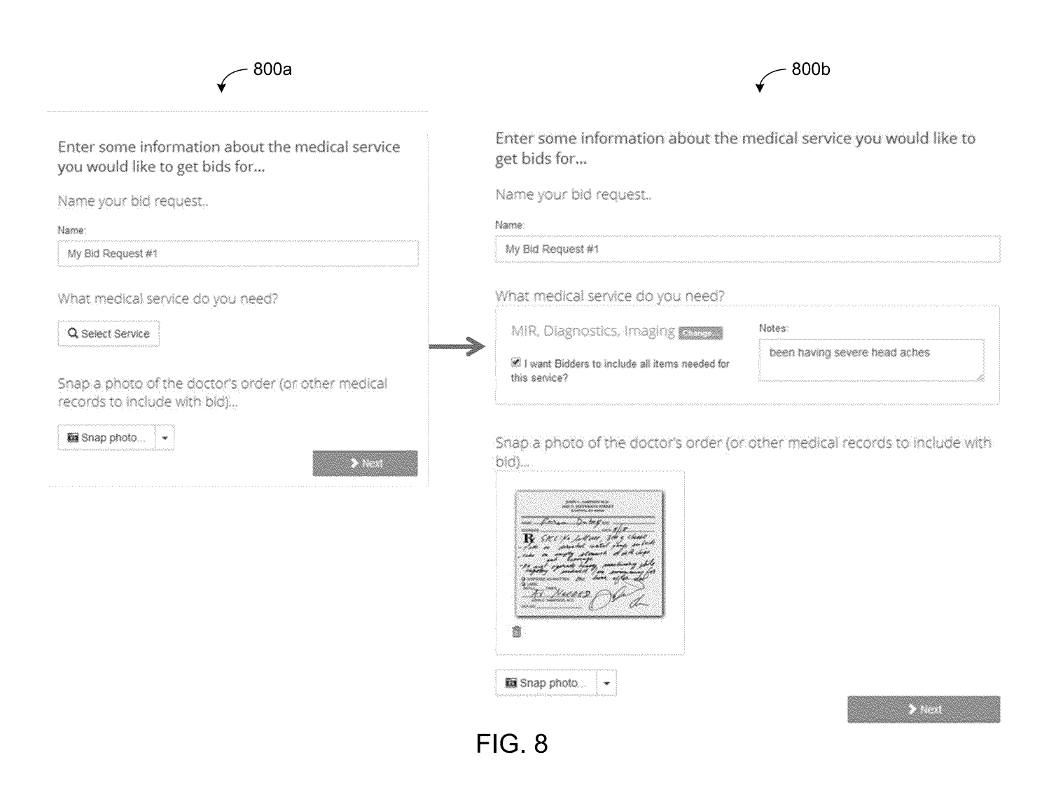

FIG. 8 is a screenshot of example graphical user interfaces 800a and 800b for bid requests in accordance with various embodiments. In particular, during generation of a bid request for a desired healthcare service, the patient user can utilize the graphical user interfaces 800a and 800b to enter information regarding the desired healthcare service for which they wish to solicit bid response from healthcare provider users. As shown in FIG. 8, the graphical user interfaces 800a and 800b can permit the patient user to specify a name for the bid request to be generated, specify the desired healthcare service (e.g., MRI, diagnostic imaging), and include referral information (e.g., include an image of the order, from the referring healthcare provider user, for the desired healthcare service). As also shown in FIG. 8, the graphical user interfaces 800a and 800b can include notes regarding the desired healthcare service being requested (e.g., reason for desired healthcare service, such as chronic headaches) and can include additional instructions to be submitted with the bid request to the healthcare provider users (e.g., request to them to include in the bid response all items needed for the desired healthcare service).

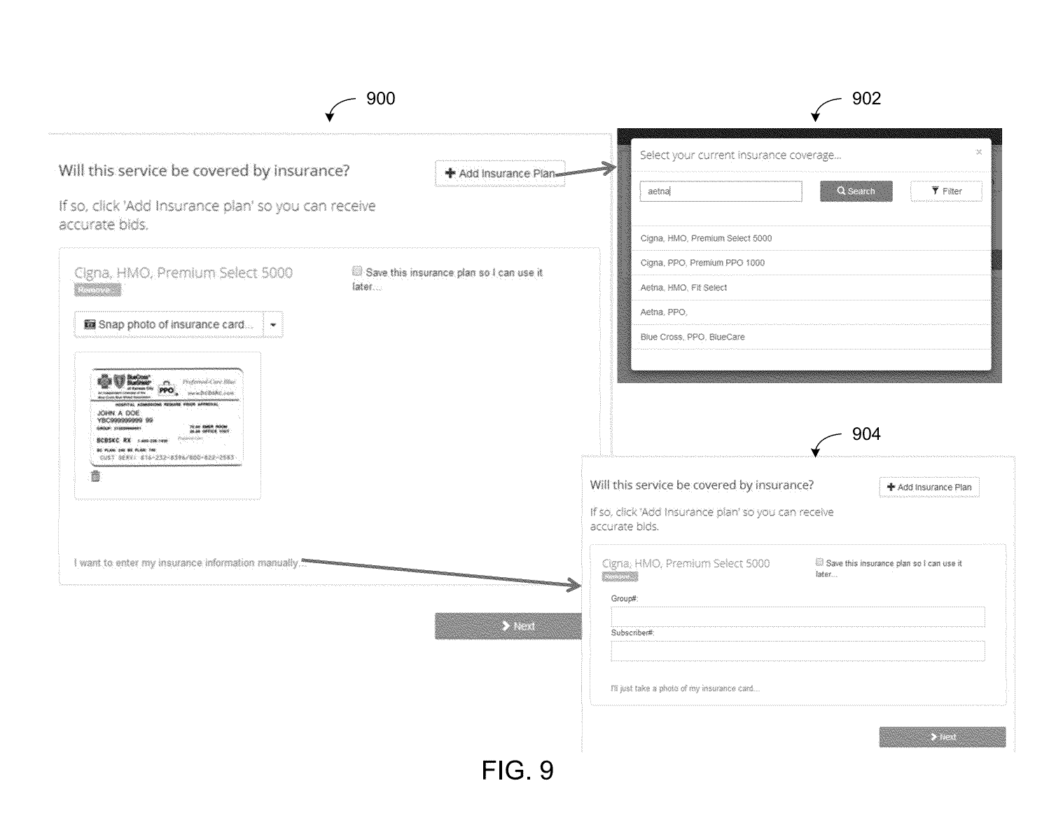

FIG. 9 is a screenshot of example graphical user interfaces 900, 902, and 904 for bid requests in accordance with various embodiments. In particular, during generation of a bid request for a desired healthcare service, the patient user can utilize the graphical user interfaces 900, 902, and 904 to include information regarding one or more insurance policies (e.g., medical insurance policy) the patient user wishes to use to cover the cost of some or all of the desired healthcare service for which the bid request is being generated. With respect to a given insurance policy, the information included in the bid request can specify insurance provider (e.g., Aetna®, Cigna®, Blue Shield®, etc.), one or more identification numbers (e.g., policy number, or group number and subscriber number), the policy holder name, insurance type (e.g., SHA, HMO, PPO, or EPO medical insurance policy), insurance plan name, level of coverage, copy of one or more insurance policy documents (e.g., front image and back image of your insurance card), and the like. As shown in FIG. 9, the patient user can utilize the graphical user interfaces 900, 902, and 904 to select from one or more insurance policies already known to the healthcare service bidding system 102 (e.g., previously entered by the patient user and then stored by the healthcare service bidding system 102) or add a new or additional insurance policy. Once the patient user selects or adds one or more of insurance policies to be used in generation of the bid request, the information for those selected or added insurance policies will be included in the bid request. The insurance policy information included in the bid request can be utilized by one or more healthcare provider users in preparing the bid (e.g., estimated cost) to be included in their bid response to the bid request. Where the patient user specifies a new or additional insurance policy for use with the bid request, after the patient user identifies the insurance provider and provides at least some identification information for the new/additional insurance policy (e.g., group number, subscriber number, or both), the healthcare service bidding system 102 may utilize such information to obtain the remaining insurance policy information (e.g., insurance type, insurance plan, insurance coverage, image of the insurance card, etc.) directly from insurance provider.

The healthcare service bidding system 102 may obtain the insurance policy information directly from insurance provider by sending an X12 (EDI-270-271) packet and request to the insurance provider. Once the EDI 271 packet is received in response to the X12 packet, the healthcare service bidding system 102 may store the response and subsequently provide access to the response to the one or more healthcare provider users receiving the bid request generated. For some embodiments, the receiving healthcare provider users can utilize the stored EDI 271 packet to assist them in determining the patient user's deductible with respect to the desired healthcare service, which may be useful when the receiving healthcare provider users are respectively preparing bid responses to the bid request.

For some embodiments, one or more of the graphical user interfaces 900, 902, and 904 may permit the patient user to indicate that they wish to self-pay for some or all of the desired healthcare service, rather than use an insurance policy to cover those costs (e.g., when the patient user lacks insurance coverage). Where the patient user indicates their intention to self-pay (e.g., pay out-of-pocket) for the desired healthcare service, such an indication may be included in the bid request generated, thereby allowing healthcare provider users to consider such information in their preparation of a bid to be included in their bid response to the bid request. Additionally, where the patient user indicates their intention to self-pay for the desired healthcare service, the healthcare service bidding system 102 may prompt the patient user for additional information to (e.g., information for a guarantor that can cover the cost of the desired healthcare service in the event the patient user fails to pay).

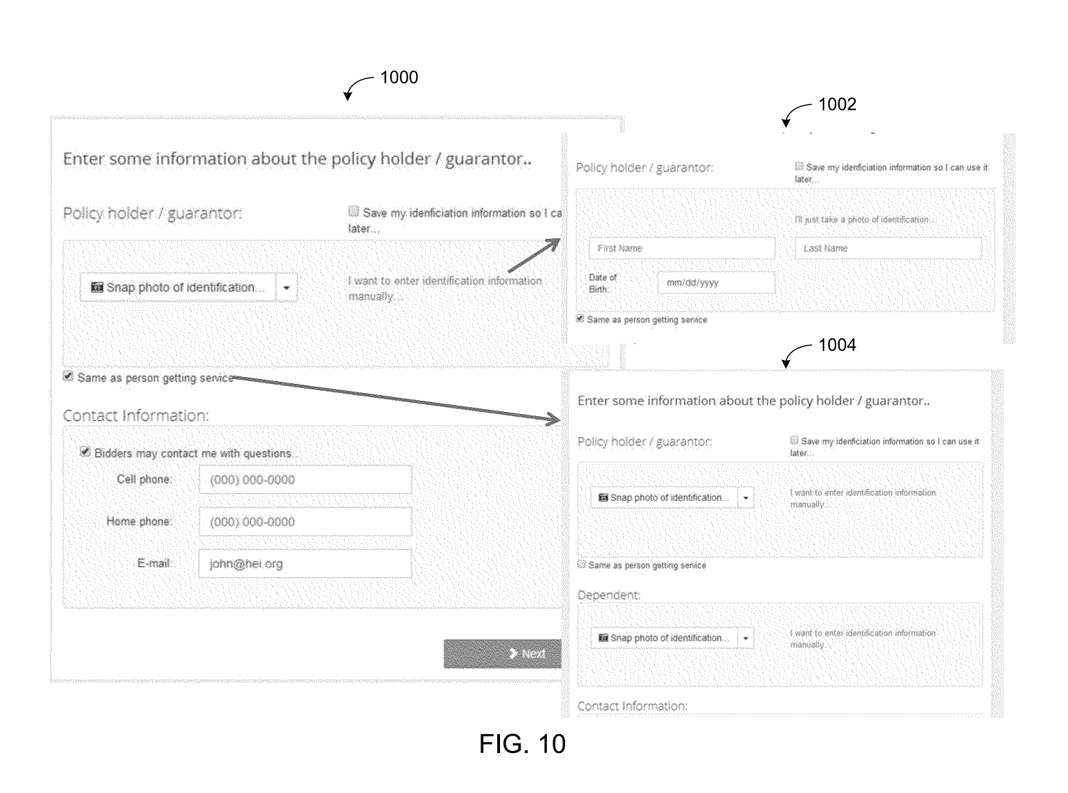

FIG. 10 is a screenshot of example graphical user interfaces 1000, 1002, and 1004 for bid requests in accordance with various embodiments. In particular, during generation of a bid request for a desired healthcare service, the patient user can utilize the graphical user interfaces 1000, 1002, and 1004 to include information regarding a guarantor for the desired healthcare service for which the bid request is being generated, or information regarding a policy holder of one or more insurance policies (e.g., medical insurance policy) the patient user wishes to use to cover the cost of some or all of the desired healthcare service for which the bid request is being generated. Information collected by way of the graphical user interfaces 1000, 1002, and 1004 can include information regarding the policy holder or the guarantor (e.g., full name, date of birth, etc.), proof of identity information for the policy holder or the guarantor (e.g., image of driver's license), contact information for the policy holder or the guarantor (e.g., phone number or e-mail address), and the like. Where the patient receiving the desired healthcare service is a dependent or a charge of the policy holder or the guarantor (e.g., child patient and policy holder is their parent), the graphical user interfaces 1000, 1002, and 1004 may include information regarding the dependent or charge receiving the desired healthcare service. In such an instance, the policy holder or the guarantor may be the patient user registered with the healthcare service bidding system 102.

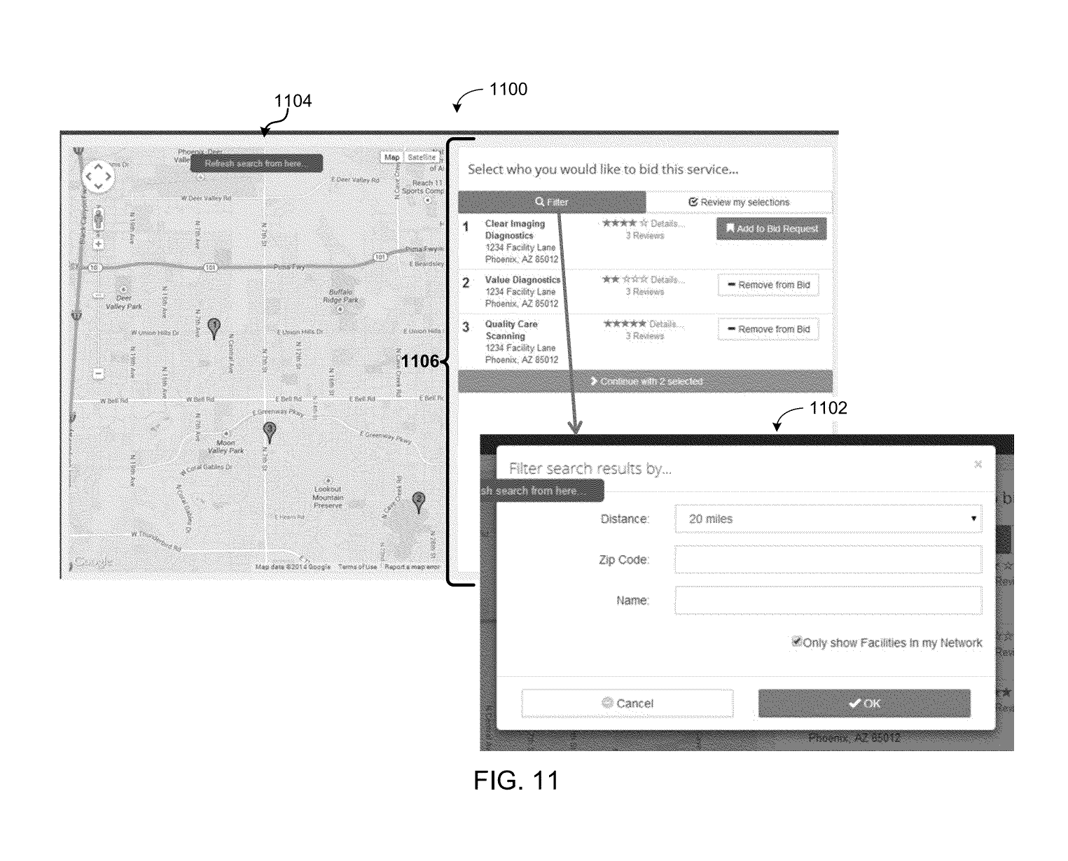

FIG. 11 is a screenshot of example graphical user interfaces 1100 and 1102 for bid requests in accordance with various embodiments. In particular, during generation of a bid request for a desired healthcare service, the patient user can utilize the graphical user interfaces 1100 and 1002 to search for, select or otherwise specify one or more healthcare provider users (e.g., specialists) to whom the patient user wishes to submit the generated bid request for consideration (e.g., a bid response). As shown in FIG. 11, the graphical user interface 1100 can include a graphical user interface feature 1102 configured to present on a map the location of one or more healthcare provider users that the patient user may select as the healthcare provider users who will receive the generated bid request.

As also shown in FIG. 11, the graphical user interface 1100 can include a graphical user feature 1104 that provides a listing of healthcare provider users from which the patient user can select one or more healthcare provider users to receive the generated bid request. Some or all of the healthcare provider users listed by the graphical user interface feature 1104 may have their location (e.g., business address) presented on map provided by the graphical user interface feature 1102. Depending on the embodiment, the healthcare provider users presented by the graphical user interface feature 1102 or 1104 is based on one or more search parameters provided (e.g., zip code or healthcare provider name entered) by the patient user (e.g., healthcare provider name or address), the current location of the patient user (e.g., based on GPS information provided by a mobile client device), or based on information the healthcare service bidding system 102 already posses with respect to the patient user (e.g., the patient user's current residential address or healthcare information, which may be included in the patient user's user profile). The initial set of healthcare provider users presented by the graphical user interface feature 1102 or 1104 can be filtered the patient user based on one or more filter parameters (e.g., keywords or attributes related to the healthcare provider users, such as zip code, distance from the patient user, healthcare provider name, and the like).

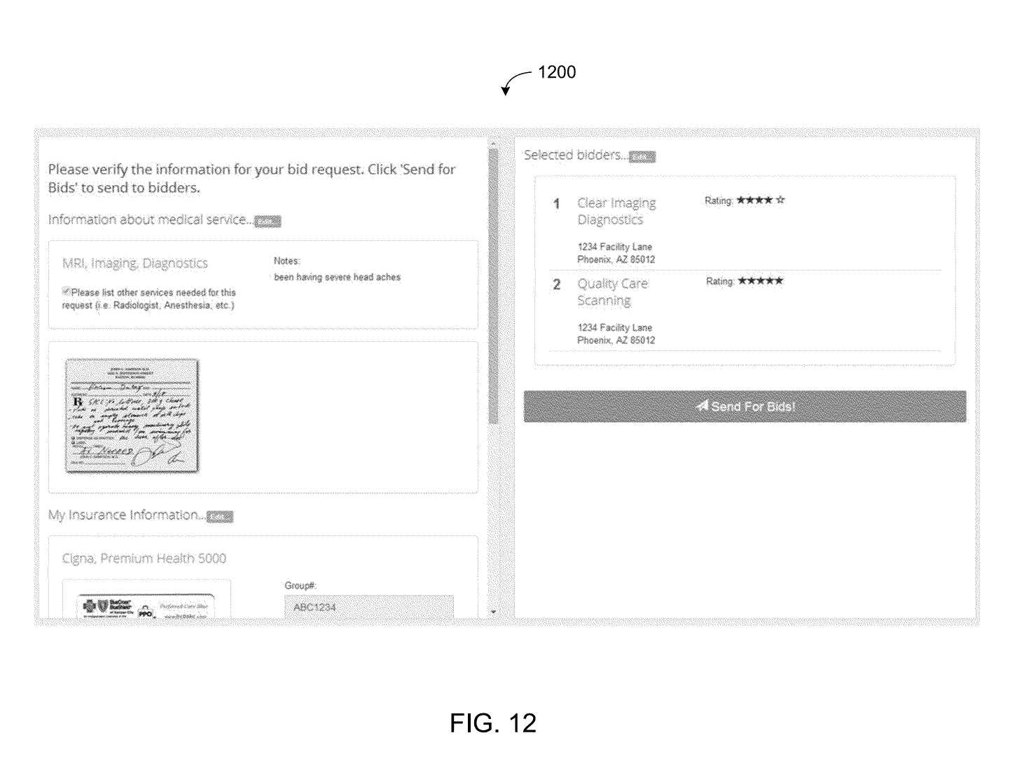

FIG. 12 is a screenshot of an example graphical user interface 1200 for bid requests in accordance with various embodiments. In particular, during generation of a bid request for a desired healthcare service, the patient user can utilize the graphical user interface 1200 to verify information included in a bid request before the bid request is submitted and then routed for to one or more healthcare provider users for their consideration. Through the graphical user interface 1200, the patient user can verify in the bid request such information as information regarding the desired healthcare service being requested, insurance information for the desired healthcare service, the one or more healthcare provider users selected to receive the bid request generated for the desired healthcare service.

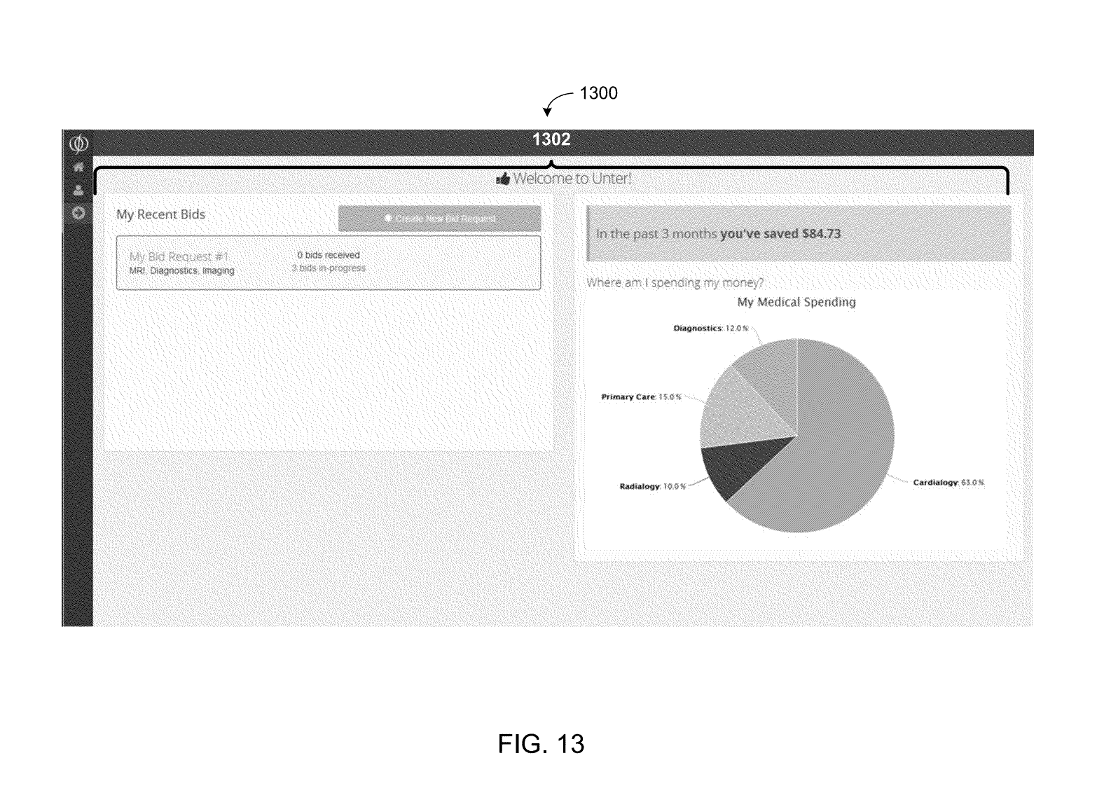

FIG. 13 is a screenshot of an example graphical user interface 1300 for bid requests in accordance with various embodiments. As shown in FIG. 13, the graphical user interface 1300 can include graphical user interface features 1302 that can provide the patient user with information relating to bid requests they have already generated, such information including the current status of the generated bid requests and details regarding the desired healthcare service through those bid requests. For instance, the graphical user interface 1300 can display an active bid request submitted by the patient user for the desired healthcare service, such as a MRI diagnostics imaging. For an active bid request displayed by the graphical user interface features 1302, the active bid request can display the number bid response received for the active bid request, and display the number of bid responses still pending receipt (e.g., bids in-progress).

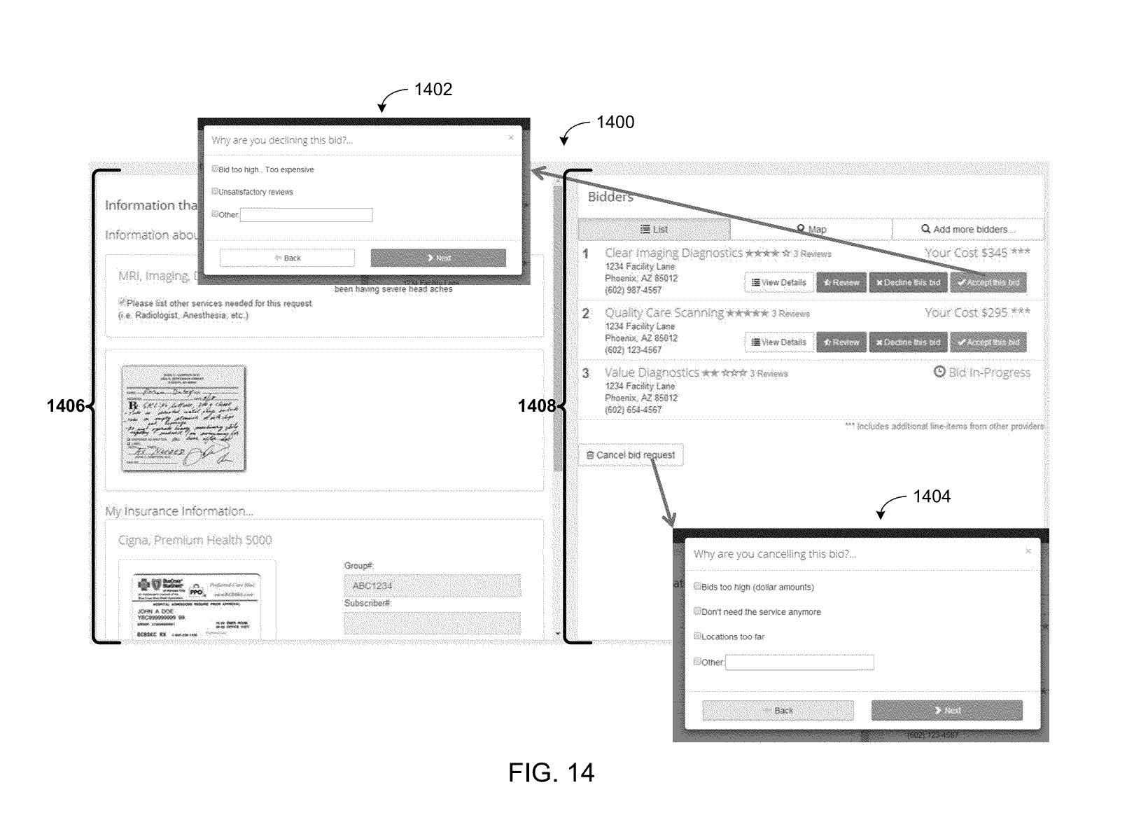

FIG. 14 is a screenshot of example graphical user interfaces 1400, 1402, and 1404 for bid responses in accordance with various embodiments. In particular, a patient user can utilize the graphical user interface 1400 to review bid responses received from one or more healthcare provider users with respect to a bid request. As shown in FIG. 14, the graphical user interface 1400 can include graphical user interface features 1406 and 1408, which can assist the patient user with review of the received bid responses. The graphical user interface feature 1406 can provide details or a summary regarding the bid request associated with the bid responses being reviewed. The graphical user interface feature 1408 may provide a listing of the bid responses received with respect to the bid request, where the listing may present the received bid responses according to the business name associated with each healthcare provider user, rating of the healthcare provider users, total cost to the patient user, map location, or the like. With respect to each of the bid response listed in the graphical user interface feature 1408, the patient user can select to view details regarding the bid response, submit a review with respect to the healthcare provider user submitting the bid response, reject the bid response (e.g., decline the bid), or accept the bid response (e.g., accept the bid). As described herein, when the patient user accepts or rejects a bid response, a patient response to the bid response may be generated on behalf of the patient user and submitted (e.g., internally routed to) the healthcare provider user. Depending on the embodiment, the graphical user interface 1400 may permit the patient user to send the bid request to additional healthcare provider users than previously sent, or remove one of the healthcare provider users from the bid request (e.g., cancel the bid request with respect to one of the healthcare provider users who previously received the bid request from the patient user).

For some embodiments, the patient user is prompted with the graphical user interface 1402 when the patient user rejects one of the bid responses listed in the graphical user interface features 1408. The graphical user interface 1402 may be utilized to collect the reason or reasons for why the patient user rejected the bid response (e.g., bid too high, unsatisfactory reviews, or some other reason). Similarly, for various embodiments, the patient user is prompted with a graphical user interface (not shown) when the patient user accepts one of the bid responses listed in the graphical user interface features 1408. Such a graphical user interface may be utilized to collect the reason or reasons for why the patient user accepted the bid response (e.g., acceptable bid, great reviews, or location, etc.). The healthcare provider user corresponding to an accepted or rejected bid response may be informed of the acceptance or rejection and may be provided with any reasons provided by the patient user for the acceptance or rejection. In some embodiments, the patient user is prompted with the graphical user interface 1404 when the patient user cancels the bid request with respect to one of the healthcare provider users that previously received the bid request from the patient user. The graphical user interface 1404 may be utilized to collect the reason or reasons for why the patient user is canceling a bid request with one of the healthcare provider users that previously received the bid request from the patient user.

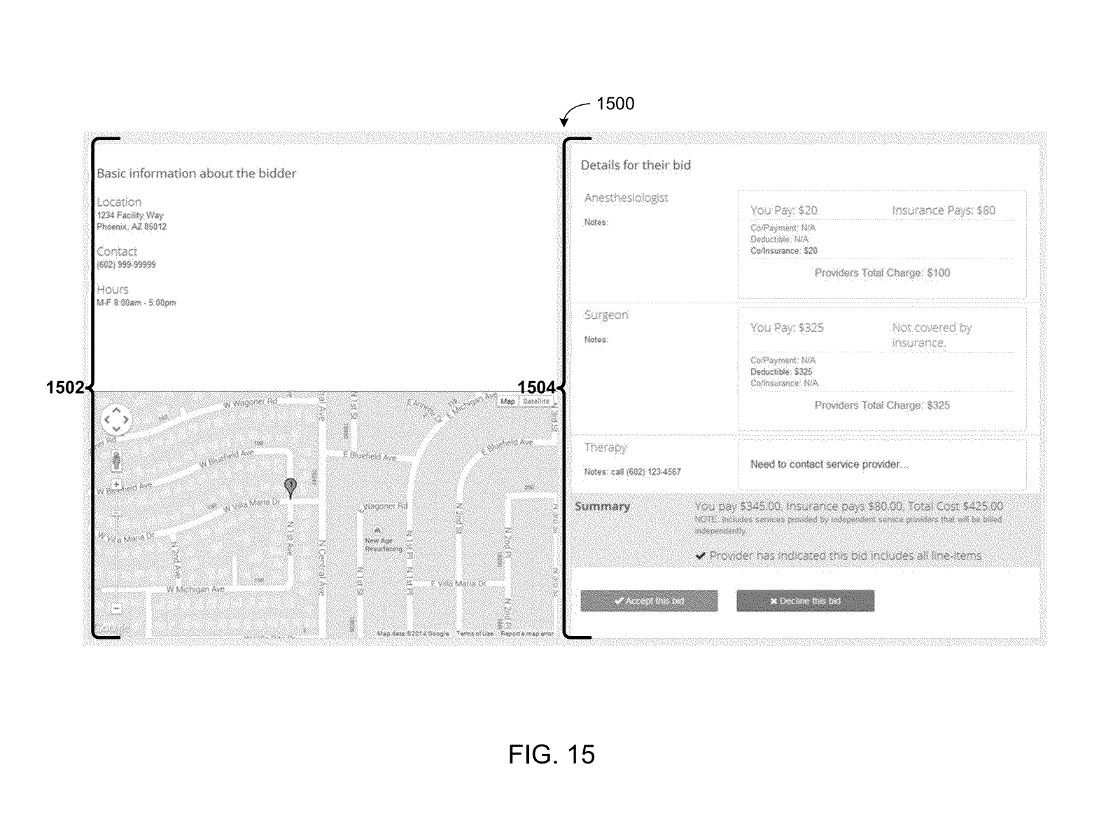

FIG. 15 is a screenshot of an example graphical user interface 1500 for bid responses in accordance with various embodiments. In particular, the patient user can utilize the graphical user interface 1500 to review details regarding a bid response received from one of the healthcare provider users with respect to a bid request. As shown in FIG. 15, the graphical user interface 1500 can include graphical user interface features 1502 and 1504, which can assist the patient user with review a particular bid response. The graphical user interface feature 1502 can provide the patient user with general information regarding the healthcare provider user associated with the bid response currently being reviewed, such general information including an address, map location, contact information, and hours of business. The graphical user interface features 1504 can provide the patient user with information regarding the healthcare provider user's bid for providing the patient user with the desired healthcare service specified in the bid request.

As also shown in FIG. 15, the bid information presented through the graphical user interface feature 1504 can include line-item cost details for the healthcare provider user providing the desired healthcare service. Examples of line-items costs can include the labor cost of each healthcare provider member involved in providing the desired healthcare service, the cost for usage of equipment during the desired healthcare service, cost of expendable goods during the desired healthcare service (e.g., medical supplies), and the like. The bid information presented can also include a breakdown of the patient user's out-of-pocket cost, insurance coverage of costs, co-payment, deductible, or total cost with respect to a particular line-item of the desired healthcare service, or the patient user's out-of-pocket cost, insurance coverage of costs (e.g., insurance payment), co-payment, deductible, or total cost with respect to the desired healthcare service as a whole. The graphical user interface feature 1504 may also indicate whether aspects (e.g., line-items) of the desired healthcare service will be covered by insurance, and by how much. Through the graphical user interface feature 1504, the patient user may accept or reject the bid response. As described herein, when the patient user accepts or rejects a bid response, a patient response to the bid response may be generated on behalf of the patient user and submitted (e.g., internally routed to) the healthcare provider user.

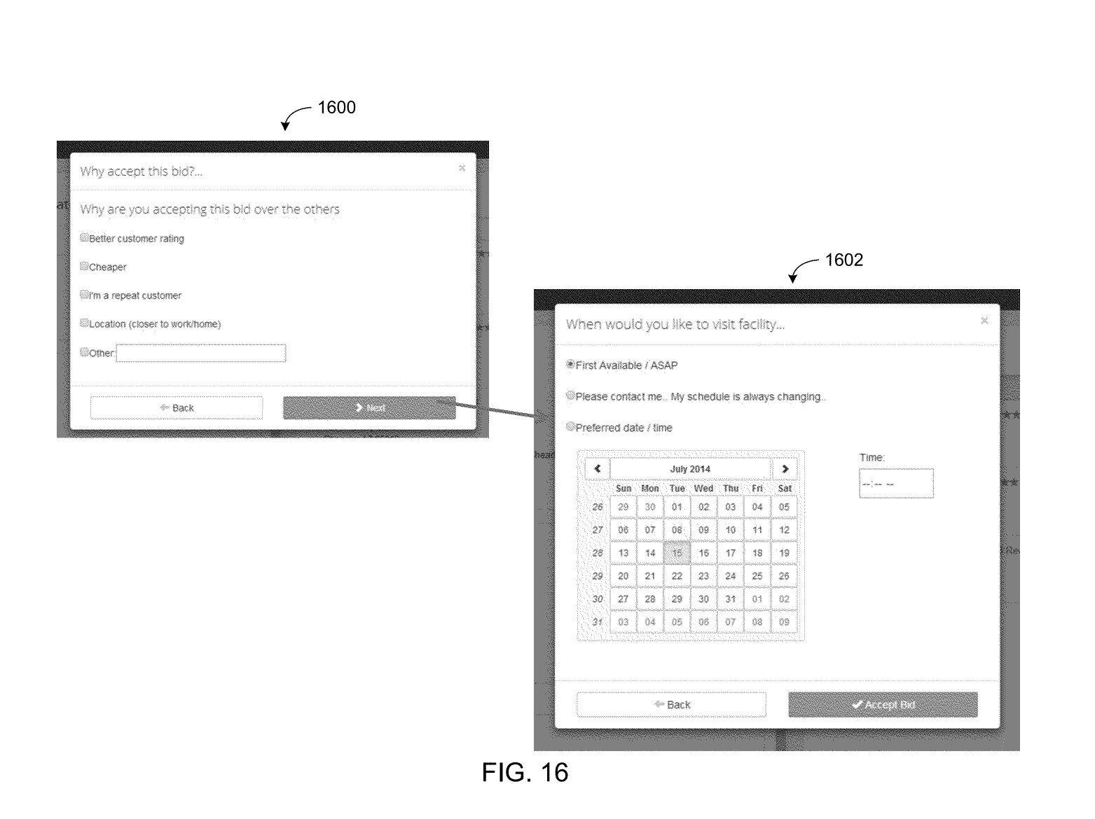

FIG. 16 is a screenshot of example graphical user interfaces 1600 and 1602 for patient responses in accordance with various embodiments. In particular, the graphical user interface 1600 or 1602 may be presented to a patient user when the patient user accepts a bid response provided by a healthcare provider user, thereby generating a patient response to the bid response. The patient user may utilize the graphical user interface 1600 to provide one or more reasons for why they are accepting a bid response (e.g., better customer rating, cheaper bid, repeat customer, location, etc.). The patient user may utilize the graphical user interface 1602 to facilitate scheduling between the patient user and the healthcare provider user after the patient user accepts the bid response provided by the healthcare provider user (thereby making the healthcare provider the winning bidder). As shown in FIG. 16, through the graphical user interface 1602, the patient user can provide their scheduling preferences for the desired healthcare service. Example scheduling preferences can include first available (e.g., ASAP), requesting the healthcare provider user to contact the patient user to complete scheduling, a preferred time (e.g., specific time, a time range, or set of times), or a preferred date (e.g., specific date, a range of dates, or a set of dates). The reason for the acceptance obtained through the graphical user interface 1600 may be included in the patient response generated in response to the patient user accepting the bid response. Likewise, the scheduling preference obtained through the graphical user interface 1602 may be included in the patient response generated in response to the patient user accepting the bid response.

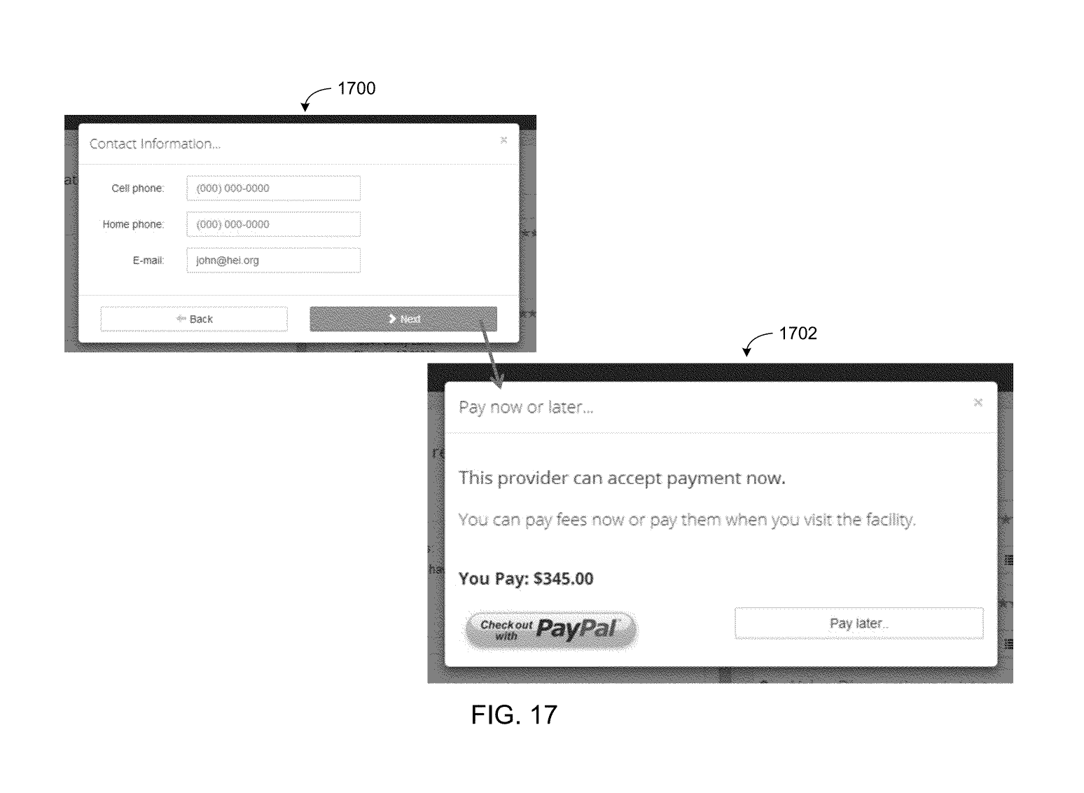

FIG. 17 is a screenshot of example graphical user interfaces 1700 and 1702 for patient responses in accordance with various embodiments. In particular, the graphical user interface 1700 or 1702 may be presented to a patient user when the patient user accepts a bid response provided by a healthcare provider user, thereby generating a patient response to the bid response. The patient user may utilize the graphical user interface 1700 to provide their contact information (e.g., cell phone, home phone number, e-mail address, etc.), which may be utilized to complete scheduling between the patient user and the healthcare provider user for the healthcare provider user providing the desired healthcare service associated with the bid response. The patient user may utilize the graphical user interface 1702 to facilitate pre-payment to the healthcare provider user for the desired healthcare service associated with the bid response. In the graphical user interface 1702, the patient user may specify the method of payment or pre-payment (e.g., PayPal®, credit card, etc.), and may specify the amount to be paid or pre-paid. Through the graphical user interface 1702, the patient user may also indicate their preference to pay or pre-pay for the desired healthcare service at a later time. The contact information obtained through the graphical user interface 1700 may be included in the patient response generated in response to the patient user accepting the bid response. Likewise, the payment preference obtained through the graphical user interface 1702 may be included in the patient response generated in response to the patient user accepting the bid response.

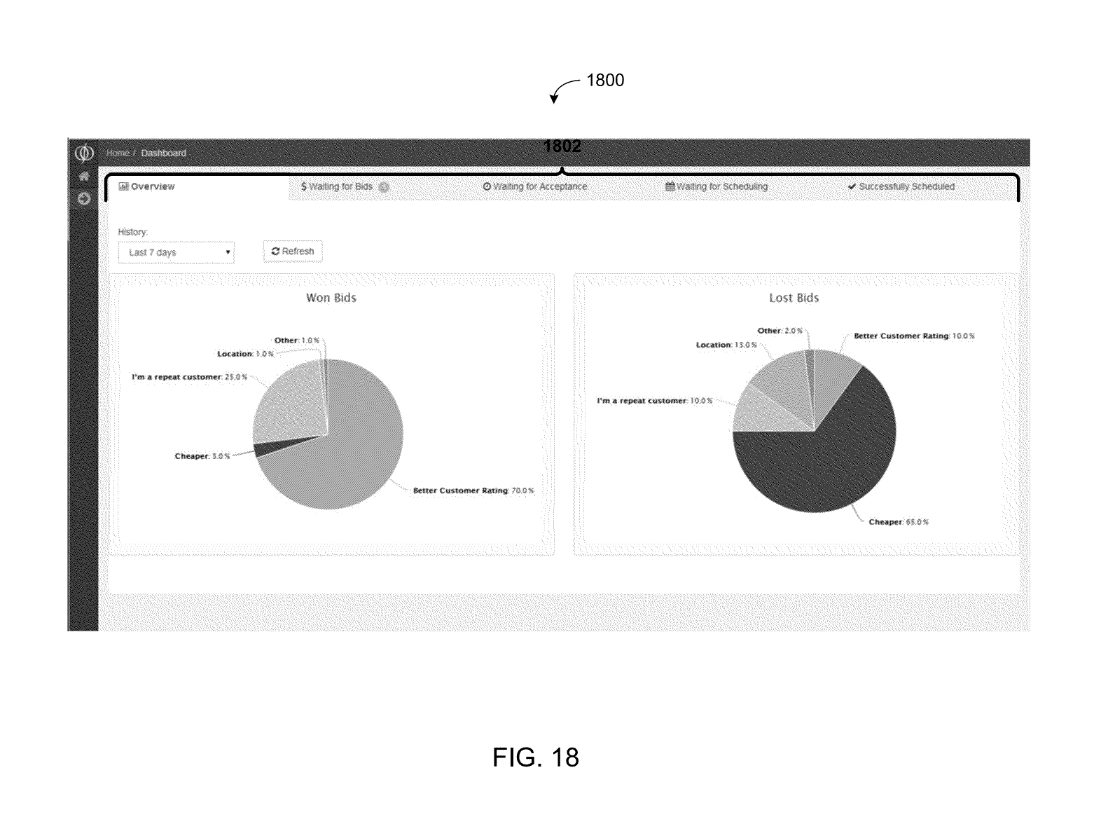

FIG. 18 is a screenshot of an example graphical user interface 1800 for a patient user dashboard in accordance with various embodiments. As shown in FIG. 18, the graphical user interface 1800 can include graphical user interface features 1802 that can permit the healthcare provider user to review information regarding one or more bid responses accepted by patient users (e.g., how many bids were won by the healthcare provider user) and information one or more bid responses accepted by patient users (e.g., how many bids were lost by the healthcare provider user). The graphical user interface features 1802 may permit the healthcare provider user to access and subsequently review: bid requests that have been submitted to the healthcare provider user by one or more patient users; bid responses submitted by the healthcare provider user and are awaiting a patient response (e.g., acceptance or rejection); bid responses, submitted by the healthcare provider user and accepted by one or more patient users, that are awaiting scheduling for the desired healthcare service; and desired healthcare services that have been successfully scheduled between the healthcare provider user and one or more patient users.

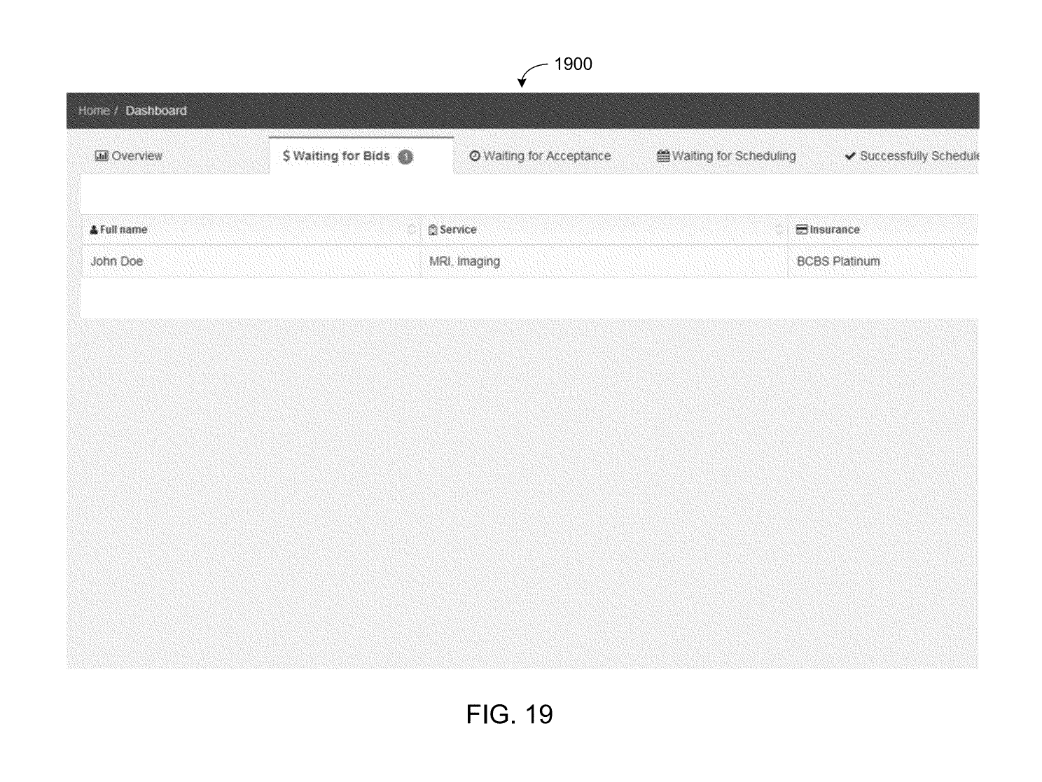

For example, FIG. 19 provides a screenshot of an example graphical user interface 1900 for a healthcare provider user dashboard that presents one or more bid requests that have been submitted to a healthcare provider user, by one or more patient users, for the healthcare provider user's consideration. As described herein, the healthcare provider user may ignore one or more of the bid requests listed in the graphical user interface 1900, or may select to respond to one or more of those bid requests with bid responses. Eventually, a bid request listed by the graphical user interface 1900 may be removed from the graphical user interface 1900. This may occur, for example, after the healthcare provider user responds the bid request, after a patient user associated with the bid request cancels the bid request with respect to the healthcare provider user, after the patient user associated with the bid request accepts a bid response to the bid request from another healthcare provider user, or after the bid request expires (e.g., where the patient user assigns an expiration time or date to the bid request).

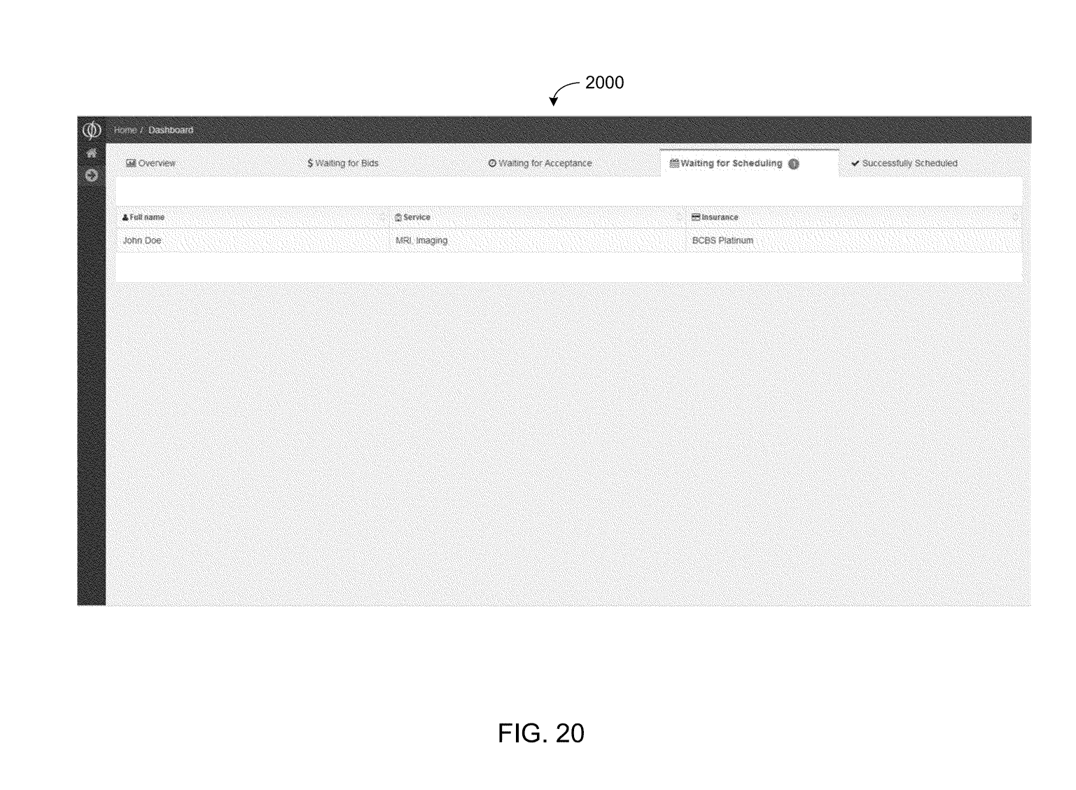

As another example, FIG. 20 provides a screenshot of an example graphical user interface 2000 for a healthcare provider user dashboard that presents bid responses that have been submitted by a healthcare provider user, accepted by one or more patient users, and are awaiting scheduling for the desired healthcare service. Through the graphical user interface 2000, the healthcare provider user can initiate a scheduling process with respect to one or more of the patient-accepted bid responses listed in the graphical user interface 2000. A patient-accepted bid response listed by the graphical user interface 2000 may eventually be removed from the graphical user interface 2000, for example: after the healthcare provider user has initiated a scheduling process with the patient user associated with the accepted bid response; after the healthcare provider user has completed a scheduling process with the patient user associated with the accepted bid response; after a bid request associated with the patient-accepted bid response has expired (e.g., where the patient user assigns an expiration time or date to the bid request); or after the bid request associated with the patient-accepted bid response has been canceled with respect to the healthcare provider user.

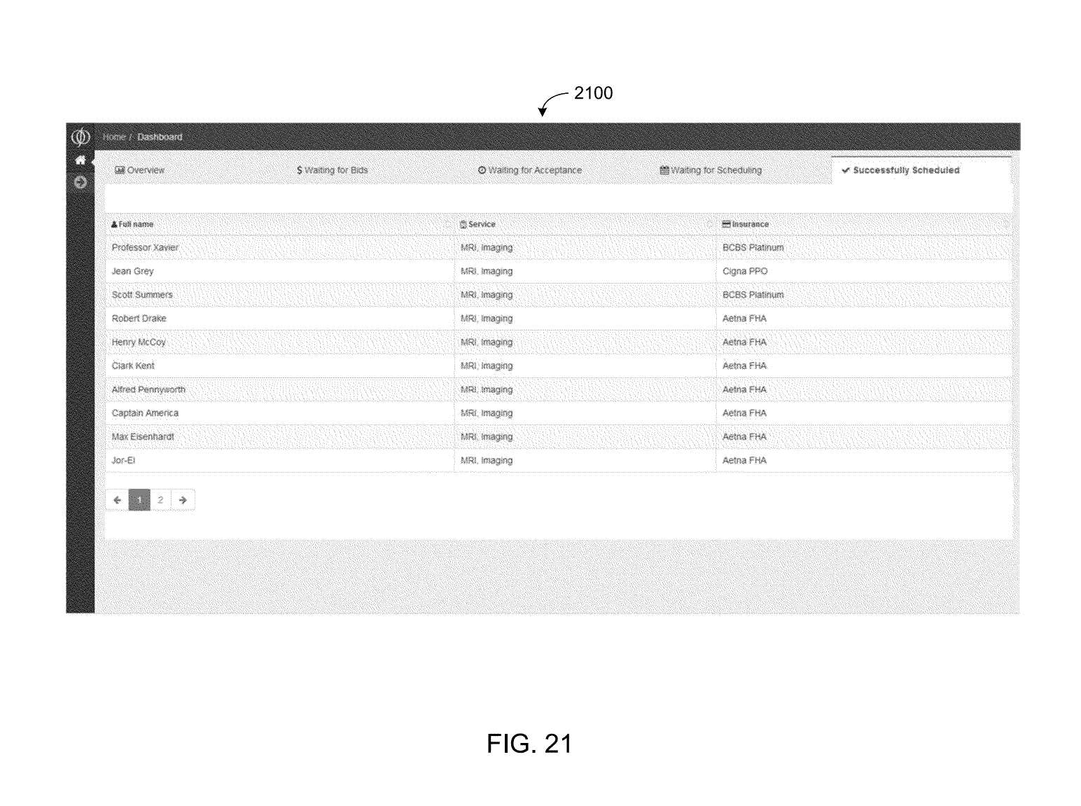

As another example, FIG. 21 provides a screenshot of an example graphical user interface 2100 for a healthcare provider user dashboard that presents desired healthcare services that have been successfully scheduled between the healthcare provider user and one or more patient users.

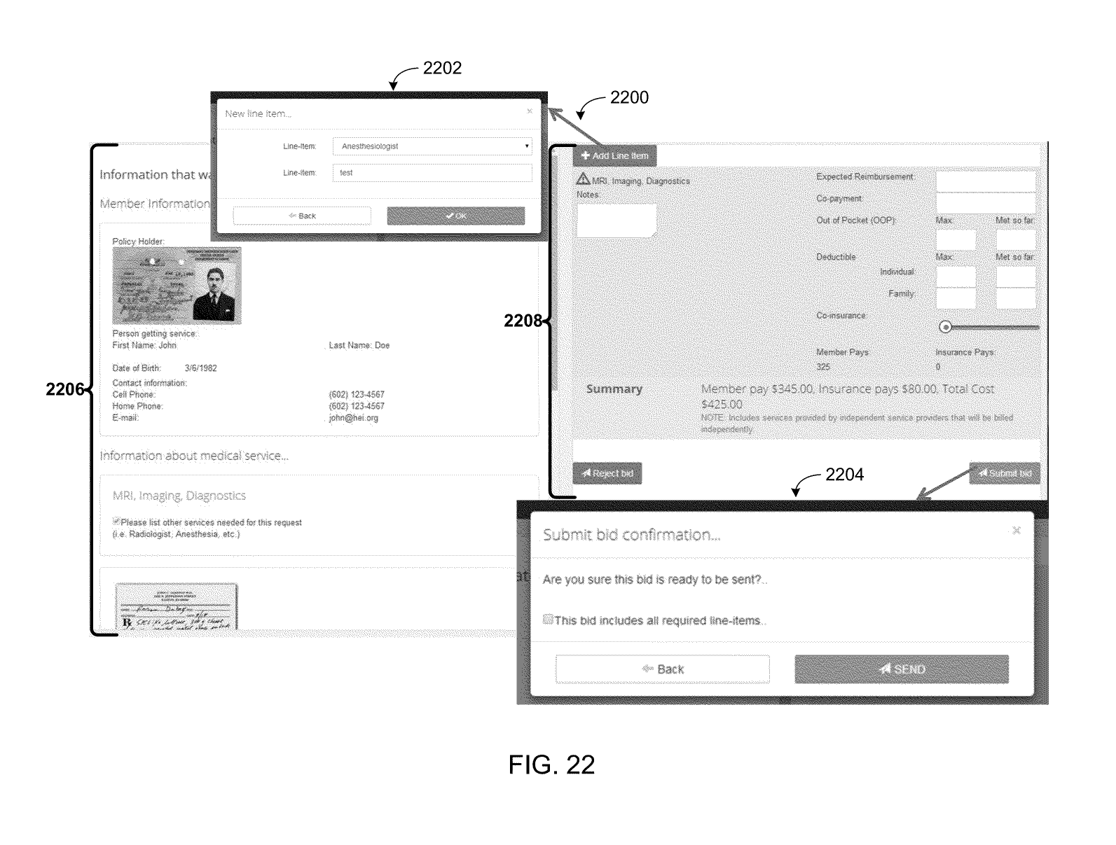

FIG. 22 is a screenshot of example graphical user interfaces 2200, 2202, and 2204 for bid responses in accordance with various embodiments. In particular, a healthcare provider user can utilize the graphical user interface 2200 to review a bid request received from a patient user and generate a bid response in response to the bid request. As shown in FIG. 22, the graphical user interface 2200 can include graphical user interface features 2206 and 2208, which can assist the patient user with reviewing, and preparing a bid response to, the bid request. The graphical user interface feature 2206 can provide information regarding the bid request that healthcare provider user can review before or during preparation of the bid response. The bid request information presented can include, for example, identification information for the patient user intending to receive the desired healthcare service specified by the bid request (e.g., copy of government identification, full legal name, date of birth, contact information, etc.), information regarding the desired healthcare service to be provided to the patient user, information regarding serving as the basis for the desired healthcare service specified in the bid request (e.g., image of the medical order from the referring healthcare provider), and the like.

The graphical user interface feature 2208 may permit the healthcare provider user to enter the details for their bid response, and may further permit him or her to enter such details as line-items. Example of line-items the healthcare provider may enter include bid amounts for good or services provided by the healthcare provider user when the patient user receives the desired healthcare service through the healthcare provider. Additional examples include bid amounts for goods or service provided by another healthcare provider that may be involved the desired healthcare service being received by the patient user through the healthcare provider user (e.g., another healthcare provider that is providing a service that is required in providing the desired healthcare service). The healthcare provider user may include notes in the bid response (e.g., note associated with one or more line-items or the associated with the bid response in general), information regarding the cost for providing the desired healthcare service through the healthcare provider user (e.g., cost by line-item or as a whole), and the like. The information regarding cost can describe the patient user's out-of-pocket cost, the insurance coverage of costs, and the patient's total cost, and may do so on a line-item basis.

As shown in FIG. 22, the healthcare provider user may be prompted with the graphical user interface 2202 when they select to enter a new line-item to the bid response. Through the graphical user interface 2202, the healthcare provider user may select to add one or more line-items to the current bid response. Once added to the bid response, some or all of the details of the added line-items may be pre-populated with system-default or user-default values, or left empty for the healthcare provider user to fill. When the healthcare provider user chooses to submit the bid response to the bid request, the healthcare provider user may be prompted with the graphical user interface 2204, which may confirm that the healthcare provider user is satisfied with the details of the bid response before the bid response is submitted.

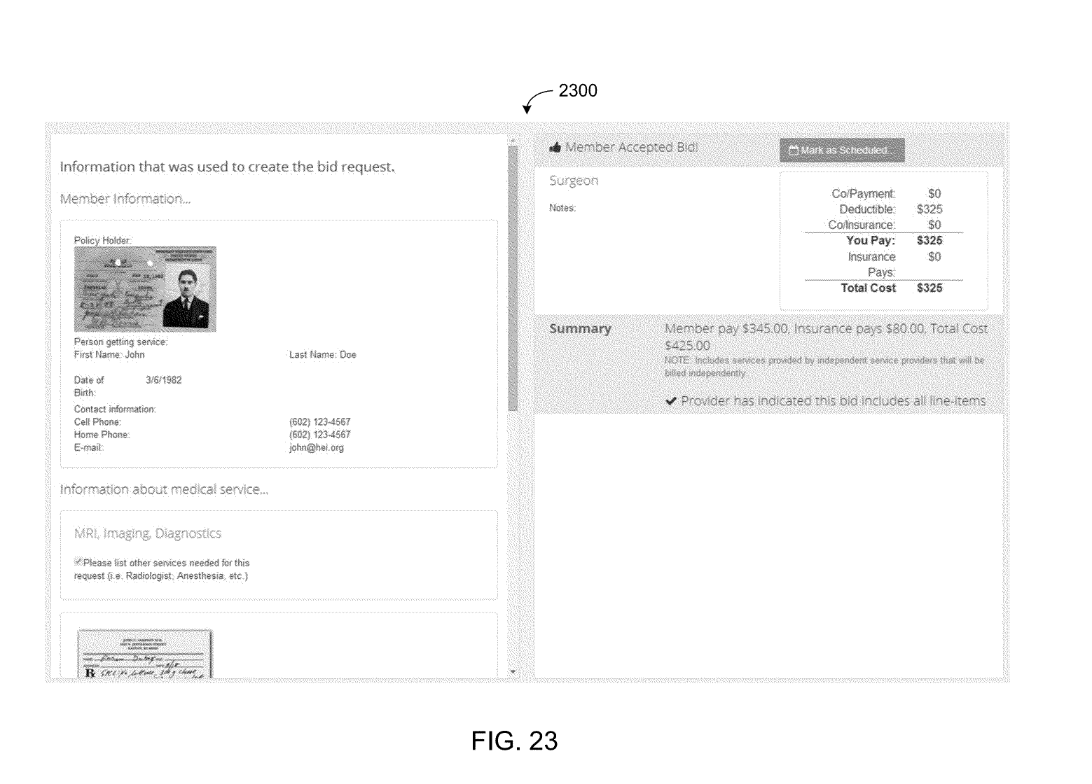

FIG. 23 is a screenshot of an example graphical user interface 2300 for patient responses in accordance with various embodiments. In particular, a healthcare provider user may be presented with the graphical user interface 2300 when the healthcare provider user is reviewing details of a patient response, from a patient user, accepting a bid response from the healthcare provider user. As shown in FIG. 23, the graphical user interface 2300 can present the healthcare provider user with information included by the bid request associated with the patient response and the bid response. For example, the bid request information presented can include identification information for the patient user intending to receive the desired healthcare service specified by the bid request (e.g., copy of government identification, full legal name, date of birth, contact information, etc.), information regarding the desired healthcare service to be provided to the patient user, information regarding the referral serving as the basis for the desired healthcare service specified in the bid request (e.g., image of the medical order from the referring healthcare provider), and the like.

Through the graphical user interface 2300, the healthcare provider user can review information regarding the bid response that was submitted by the healthcare provider user and then accepted by the patient user. The bid response information that may be reviewed may include the line-item details of the bid contained by the patient-accepted bid response, and total cost associated with the bid (e.g., the patient user's out-of-pocket cost, insurance coverage of costs, and the patient's total cost. In the event that the desired healthcare service associated with the patient response is scheduled offline (e.g., not through the healthcare service bidding system), the graphical user interface 2300 may allow the healthcare provider user to mark the patient response as successfully scheduled and may further allow the healthcare provider user to enter the corresponding scheduling information.

FIG. 24 is a block diagram of an exemplary digital device 2400. The digital device 2400 comprises a processor 2402, a memory system 2404, a storage system 2406, a communication network interface 2408, an I/O interface 2410, and a display interface 2412 communicatively coupled to a bus 2414. The processor 2402 is configured to execute executable instructions (e.g., programs). In some embodiments, the processor 2402 comprises circuitry or any processor capable of processing the executable instructions.

The memory system 2404 is any memory configured to store data. Some examples of the memory system 2404 are storage devices, such as RAM or ROM. The memory system 2404 can comprise the RAM cache. In various embodiments, data is stored within the memory system 2404. The data within the memory system 2404 may be cleared or ultimately transferred to the storage system 2406.

The storage system 2406 is any storage configured to retrieve and store data. Some examples of the storage system 2406 are flash drives, hard drives, optical drives, and/or magnetic tape. In some embodiments, the digital device 2400 includes a memory system 2404 in the form of RAM and a storage system 2406 in the form of flash data. Both the memory system 2404 and the storage system 2406 comprise computer readable media which may store instructions or programs that are executable by a computer processor including the processor 2402.

The communications network interface (com. network interface) 2408 can be coupled to a network (e.g., the computer network 104) via the link 2416. The communication network interface 2408 may support communication over an Ethernet connection, a serial connection, a parallel connection, or an ATA connection, for example. The communication network interface 2408 may also support wireless communication (e.g., 802.11 a/b/g/n, WiMax). It will be apparent to those skilled in the art that the communication network interface 2408 can support many wired and wireless standards.

The optional input/output (I/O) interface 2410 is any device that receives input from the user and output data. The optional display interface 2412 is any device that is configured to output graphics and data to a display. In one example, the display interface 2412 is a graphics adapter.

It will be appreciated by those skilled in the art that the hardware elements of the digital device 2400 are not limited to those depicted in FIG. 24. A digital device 2400 may comprise more or less hardware elements than those depicted. Further, hardware elements may share functionality and still be within various embodiments described herein. In one example, encoding and/or decoding may be performed by the processor 2402 and/or a co-processor located on a GPU (i.e., NVidia®).

The above-described functions and components can be comprised of instructions that are stored on a storage medium such as a computer readable medium. The instructions can be retrieved and executed by a processor. Some examples of instructions are software, program code, and firmware. Some examples of storage medium are memory devices, tape, disks, integrated circuits, and servers. The instructions are operational when executed by the processor to direct the processor to operate in accord with some embodiments. Those skilled in the art are familiar with instructions, processor(s), and storage medium.

Various embodiments are described herein as examples. It will be apparent to those skilled in the art that various modifications may be made and other embodiments can be used without departing from the broader scope of the invention(s) presented herein. These and other variations upon the exemplary embodiments are intended to be covered by the present invention(s).

What is claimed is:

1. A system comprising:
a digital processor;
a bid request module configured to cause the digital processor to generate a bid request for a desired healthcare service to be received by a patient, and further configured to cause the digital processor to route the bid request to a subset of a set of healthcare provider users, the subset of healthcare provider users being selected by the patient from the set of healthcare provider users;
a healthcare provider module configured to cause the digital processor to determine, based on the bid request, the set of healthcare provider users that can provide the desired healthcare service;
a bid response module configured to cause the digital processor to receive, from at least one healthcare provider user in the subset of healthcare provider users, a bid response to the bid request, and further configured to cause the digital processor to route the bid response to the patient; and
a patient response module configured to cause the digital processor to receive a patient response to the bid response.

2. The system of claim 1, wherein the generating the bid request is in response to a referral, by a referring healthcare provider user, for the patient to receive the desired healthcare service.

3. The system of claim 1, wherein the healthcare provider module is further configured to cause the digital processor to determine the subset of the set of healthcare provider users by receiving, from the patient, a set of selections of healthcare provider users in the set of healthcare provider users.

4. The system of claim 1, further comprising an appointment module configured to cause the processor to schedule an appointment, with the at least one healthcare provider user, for the desired healthcare service, the scheduling being based on the patient response.

5. The system of claim 1, wherein the bid response comprises an acceptance or a rejection of the bid request by the at least one healthcare provider user.

6. The system of claim 5, wherein the bid response further comprises a reason, by the at least one healthcare provider user, for the acceptance or the rejection.

7. The system of claim 1, wherein the bid response comprises a bid by the at least one healthcare provider user for providing the patient the desired healthcare service, cost information for the desired health service, description of the desired health service as offered by the at least one healthcare provider user, patient co-payment information, patient deductible information, co-insurance contribution information, or patient out of pocket (OOP) cost information.

8. The system of claim 1, wherein the bid request comprises information regarding healthcare information of the patient, a healthcare service type of the desired healthcare service, a parameter of the desired healthcare service, or a referral instruction by the patient's healthcare provider user for the desired healthcare service.

9. The system of claim 1, wherein the patient response comprises an acceptance or a rejection of the bid response by the patient.

10. The system of claim 9, wherein the patient response further comprises a reason, by the patient, for the acceptance or the rejection.

11. The system of claim 1, further comprising a payment module configured to cause the digital processor to process pre-payment for the desired healthcare service, the pre-payment being based on the patient response or the bid response.

12. The system of claim 1, wherein the patient response comprises a counter bid to the bid response.

13. The system of claim 1, further comprising a patient review module configured to cause the digital processor to receive from the patient a patient review of the desired healthcare service provided to the patient by the at least one healthcare provider user.

14. A method comprising:
generating a bid request for a desired healthcare service to be received by a patient;
determining, based on the bid request, a set of healthcare provider users that can provide the desired healthcare service;
routing the bid request to a subset of the set of healthcare provider users, the subset of healthcare provider users being selected by the patient from the set of healthcare provider users;
receiving, from at least one healthcare provider user in the subset of healthcare provider users, a bid response to the bid request;
routing the bid response to the patient; and
receiving a patient response to the bid response.

15. The method of claim 14, wherein the generating the bid request is in response to a referral, by a referring healthcare provider user, for the patient to receive the desired healthcare service.

16. The method of claim 14, further comprising determining the subset of the set of healthcare provider users by receiving, from the patient, a set of selections of healthcare provider users in the set of healthcare provider users.

17. The method of claim 14, further comprising scheduling an appointment, with the at least one healthcare provider user, for the desired healthcare service, the scheduling being based on the patient response.

18. The method of claim 14, wherein the bid response comprises an acceptance or a rejection of the bid request by the at least one healthcare provider user.

19. The method of claim 18, wherein the bid response further comprises a reason, by the at least one healthcare provider user, for the acceptance or the rejection.

20. The method of claim 14, wherein the bid response comprises a bid by the at least one healthcare provider user for providing the patient the desired healthcare service, cost information for the desired health service, description of the desired health service as offered by the at least one healthcare provider user, patient co-payment information, patient deductible information, co-insurance contribution information, or patient out-of-pocket (OOP) expense information.

21. The method of claim 14, wherein the bid request comprises information regarding healthcare information of the patient, a healthcare service type of the desired healthcare service, a parameter of the desired healthcare service, or a referral instruction by the patient's healthcare provider user for the desired healthcare service.

22. The method of claim 14, wherein the patient response comprises an acceptance or a rejection of the bid response by the patient.

23. The method of claim 22, wherein the patient response further comprises a reason, by the patient, for the acceptance or the rejection.

24. The method of claim 14, further comprising processing pre-payment for the desired healthcare service, the pre-payment being based on the patient response or the bid response.

25. The method of claim 14, wherein the patient response comprises a counter bid to the bid response.

26. The method of claim 14, further comprising receiving, from the patient, a patient review of the desired healthcare service provided to the patient by the at least one healthcare provider user.

27. A system comprising:
means for generating a bid request for a desired healthcare service to be received by a patient;
means for determining, based on the bid request, a set of healthcare provider users that can provide the desired healthcare service;
means for routing the bid request to a subset of the set of healthcare provider users, the subset of healthcare provider users being selected by the patient from the set of healthcare provider users;
means for receiving, from at least one healthcare provider user in the subset of healthcare provider users, a bid response to the bid request;
means for routing the bid response to the patient; and
means for receiving a patient response to the bid response.
